(19) United States
(12) Patent Application Publication
(10) Pub. No.: US 2026/0156329 A1
(43) Pub. Date: Jun. 4, 2026

(54) ELECTRONIC DEVICE AND METHOD FOR DISPLAYING VISUAL CONTENT

(71) Applicant: Samsung Electronics Co., Ltd., Suwon-si (KR)

(72) Inventors: Songhee JUNG, Suwon-si (KR); Jinug CHOI, Suwon-si (KR); Jeongho KANG, Suwon-si (KR); Seho CHANG, Suwon-si (KR); Shinhyuk YOON, Suwon-si (KR); Sunglak KIM, Suwon-si (KR)

(21) Appl. No.: 19/436,212

(22) Filed: Dec. 30, 2025

Related U.S. Application Data
(63) Continuation of application No. PCT/KR2025/019889, filed on Nov. 27, 2025.

(30) Foreign Application Priority Data
Nov. 29, 2024 (KR) 10-2024-0175633
Dec. 9, 2024 (KR) 10-2024-0181471

(51) Int. Cl. H04N 21/81; H04N 21/431; H04N 21/485; H04N 21/488

(52) U.S. Cl. CPC H04N 21/816; H04N 21/4316; H04N 21/4318; H04N 21/4854; H04N 21/4884

(57) ABSTRACT

An electronic device and a method for displaying visual content are provided. The method for displaying visual content in an electronic device includes identifying setting information on a rendering dimension that is set for a first visual content, the rendering dimension comprising a 2D rendering dimension and a 3D rendering dimension, identifying, based on the setting information, a first display area corresponding to the first rendering dimension from a display area of the first visual content, the first rendering dimension being different from a second rendering dimension, and displaying a first rendered image and a second rendered image together, wherein the first rendered image of the first visual content in the first rendering dimension is displayed in the first display area, and wherein the second rendered image of the first visual content in the second rendering dimension is displayed in a second display area.

### CROSS-REFERENCE TO RELATED APPLICATION(S)

This application is a continuation application, claiming priority under 35 U.S.C. § 365(c), of an International application No. PCT/KR2025/019889, filed on Nov. 27, 2025, which is based on and claims the benefit of a Korean patent application number 10-2024-0175633, filed on Nov. 29, 2024, in the Korean Intellectual Property Office, and of a Korean patent application number 10-2024-0181471, filed on Dec. 9, 2024, in the Korean Intellectual Property Office, the disclosure of each of which is incorporated by reference herein in its entirety.

### TECHNICAL FIELD

The disclosure relates to an electronic device and method for displaying visual content.

### BACKGROUND ART

With the development of various three-dimensional (3D) display technologies, content in various fields such as movies, games and education are being developed. In addition, applications for producing such content are spreading.

Generally, 3D videos are created by the principle of stereoscopic vision through person's two eyes, and binocular parallax caused by the distance between the two eyes is an important factor in the sense of three-dimensionality. Technologies for displaying 3D videos, include a 3D video display technology that uses glasses and a 3D video display technology that does not use glasses. The non-glasses 3D video display technology may provide the 3D videos to users without using glasses, and may obtain the 3D videos by separating a left-eye video and a right-eye video.

In addition, among the non-glasses methods, a multiview method based on a directional backlight is being developed. This directional-backlight-based multiview method is a method of forming directional light through a diffraction grating structure formed on the surface of a light guiding plate (LGP) of a backlight unit, and may provide the 3D videos by implementing low cross-talk.

However, the 3D video has a lower resolution than a two-dimensional (2D) video, and a technology for effectively providing the 2D video and the 3D video is required in providing visual content.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide an electronic device and method for displaying visual content.

Additional aspects will be set forth in part in the description which follows and, in part, will be apparent from the description, or may be learned by practice of the presented embodiments.

In accordance with an aspect of the disclosure, an electronic device for displaying visual content is provided. The electronic device includes a display structure including a display panel, a polarization layer, a lens layer, and a touch panel, a control circuit 154 configured to adjust refractive indices of a plurality of regions of the lens layer, memory, comprising one or more storage media, storing instructions, and at least one processor communicatively coupled to the display structure, the control circuit, and the memory, wherein the instructions, when executed by the at least one processor individually or collectively, cause the electronic device to identify setting information on a rendering dimension that is set for a first visual content, the rendering dimension including a two-dimensional (2D) rendering dimension and a three-dimensional (3D) rendering dimension, identify, based on the setting information, a first display area corresponding to a first rendering dimension and a second display area corresponding to a second rendering dimension, from a display area where the first visual content is to be displayed, the first rendering dimension being different from the second rendering dimension, and by controlling the control circuit, adjust the refractive indices of the lens layer, wherein a first rendered image of the first visual content in the first rendering dimension is displayed in the first display area, and wherein a second rendered image of the first visual content in the second rendering dimension is displayed in the second display area.

In accordance with another aspect of the disclosure, a method for displaying visual content in an electronic device is provided. The method includes identifying setting information on a rendering dimension that is set for a first visual content, the rendering dimension including a two-dimensional (2D) rendering dimension and a three-dimensional (3D) rendering dimension, identifying, based on the setting information, a first display area corresponding to the first rendering dimension from a display area of the first visual content, the first rendering dimension being different from a second rendering dimension, and displaying a first rendered image and a second rendered image together, wherein the first rendered image of the first visual content in the first rendering dimension is displayed in the first display area, and the second rendered image of the first visual content in the second rendering dimension is displayed in a second display area.

In accordance with another aspect of the disclosure, one or more non-transitory computer-readable recording media recording one or more computer programs including computer-executable instructions that, when executed by one or more processors of an electronic device individually or collectively, cause the electronic device to perform operations are provided. The operations include identifying setting information on a rendering dimension that is set for a first visual content, the rendering dimension including a two-dimensional (2D) rendering dimension and a three-dimensional (3D) rendering dimension, identifying, based on the setting information, a first display area corresponding to the first rendering dimension from a display area of the first visual content, the first rendering dimension being different from a second rendering dimension, and displaying a first rendered image and a second rendered image together wherein the first rendered image of the first visual content in the first rendering dimension is displayed in the first display area, and wherein the second rendered image of the first visual content in the second rendering dimension is displayed in a second display area.

In accordance with another aspect of the disclosure, an electronic device for displaying visual content is provided. The electronic device includes a display, memory configured to store instructions, and at least one processor, and the instructions, when executed by the at least one processor, cause the electronic device to set a rendering dimension related to visual content, the rendering dimension including a two-dimensional (2D) rendering dimension and a three-dimensional (3D) rendering dimension, receive a user input for displaying a first visual content, display a first rendered image of the first visual content, based on a first rendering dimension that is set for the first visual content, in response to the user input being received, receive a user input for selecting a partial region of the first rendered image, generate a second rendered image, corresponding to the partial region, of the first visual content, the second rendered image having the second rendering dimension different from the first rendering dimension, and replace the partial region of the first rendered image with the second rendered image.

In accordance with another aspect of the disclosure, a method for displaying visual content in an electronic device is provided. The method includes setting a rendering dimension related to visual content, the rendering dimension including a two-dimensional (2D) rendering dimension and a three-dimensional (3D) rendering dimension, receiving a user input for displaying a first visual content, displaying a first rendered image of the first visual content, based on a first rendering dimension that is set for the first visual content, in response to the user input being received, receiving a user input for selecting a partial region of the first rendered image, generating a second rendered image, corresponding to the partial region, of the first visual content, the second rendered image having the second rendering dimension different from the first rendering dimension, and replacing the partial region of the first rendered image with the second rendered image.

In accordance with another aspect of the disclosure, one or more non-transitory computer-readable recording media recording one or more computer programs including computer-executable instructions that, when executed by one or more processors of an electronic device individually or collectively, cause the electronic device to perform operations are provided. The operations include setting a rendering dimension related to visual content, the rendering dimension including a two-dimensional (2D) rendering dimension and a three-dimensional (3D) rendering dimension, receiving a user input for displaying a first visual content, displaying a first rendered image of the first visual content, based on a first rendering dimension that is set for the first visual content, in response to the user input being received, receiving a user input for selecting a partial region of the first rendered image, generating a second rendered image, corresponding to the partial region, of the first visual content, the second rendered image having the second rendering dimension different from the first rendering dimension, and replacing the partial region of the first rendered image with the second rendered image.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a diagram illustrating an overview of displaying visual content by replacing a portion of a rendered image of the visual content with a rendered image of another rendering dimension in an electronic device according to an embodiment of the disclosure;

FIG. 2A is a flowchart illustrating a method of displaying different rendered images of visual content in an electronic device according to an embodiment of the disclosure;

FIG. 2B is a flowchart illustrating a method of replacing a portion of a rendered image of visual content with a rendered image of another rendering dimension in an electronic device according to an embodiment of the disclosure;

FIG. 3 is a flowchart illustrating a method of setting a rendering dimension for visual content in an electronic device according to an embodiment of the disclosure;

FIG. 4A is a diagram illustrating an example of a setting icon for setting a rendering dimension of visual content according to an embodiment of the disclosure;

FIG. 4B is a diagram illustrating an example of setting a three-dimensional rendering dimension for visual content through a menu for setting a rendering dimension of visual content according to an embodiment of the disclosure;

FIG. 4C is a diagram illustrating an example of setting a two-dimensional rendering dimension for visual content through a menu for setting a rendering dimension of visual content according to an embodiment of the disclosure;

FIG. 5 is a flowchart illustrating a method of selecting a partial region of a rendered image in an electronic device according to an embodiment of the disclosure;

FIG. 6A is a diagram illustrating an example of a user input for selecting a partial region of a first rendered image according to an embodiment of the disclosure;

FIG. 6B is a diagram illustrating an example of a gesture input for selecting a partial region of a first rendered image according to an embodiment of the disclosure;

FIG. 6C is a diagram illustrating an example of a drag input for selecting a partial region of a first rendered image according to an embodiment of the disclosure;

FIG. 6D is a diagram illustrating an example of a user input for selecting, as a partial region, a visual object within a first rendered image according to an embodiment of the disclosure;

FIG. 6E is a diagram illustrating an example of a user input for selecting a partial region of a first rendered image according to an embodiment of the disclosure;

FIG. 7 is a flowchart illustrating a method of displaying rendered images of different dimensions, based on settings related to rendering dimensions, in an electronic device according to an embodiment of the disclosure;

FIG. 8 is a diagram illustrating an example of displaying rendered images of different dimensions, based on setting values related to rendering dimensions, in an electronic device according to an embodiment of the disclosure;

FIG. 9 is a flowchart illustrating a method of changing a rendering dimension of visual content, based on a user input for another visual content, in an electronic device according to an embodiment of the disclosure;

FIG. 10 is a diagram illustrating an example of changing a rendering dimension of visual content, based on a user input for another visual content, in an electronic device according to an embodiment of the disclosure;

FIG. 11 is a flowchart illustrating a method of storing information related to a rendered image and changing a dimension of a displayed rendered image by using the stored rendered image in an electronic device according to an embodiment of the disclosure;

FIG. 12 is a diagram illustrating an example of information related to a rendered image of visual content according to an embodiment of the disclosure;

FIG. 13A is a diagram illustrating an example of adjusting the brightness of a boundary between a first rendered image and a second rendered image in an electronic device according to an embodiment of the disclosure;

FIG. 13B is a diagram illustrating an example of adjusting the brightness of a first rendered image and a second rendered image in an electronic device according to an embodiment of the disclosure;

FIG. 14A is a diagram illustrating a display structure providing a two-dimensional display and a three-dimensional display according to an embodiment of the disclosure;

FIG. 14B is a diagram illustrating a display structure providing a two-dimensional display and a three-dimensional display according to an embodiment of the disclosure; and

FIG. 15 is a block diagram of an electronic device in a network environment according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In addition, terms such as first, second, etc. may be used to describe various components, but the components should not be limited by these terms. These terms are used for the purpose of distinguishing one component from another component.

Throughout the specification, when a certain portion is said to be “connected” to another portion, this includes not only a case where it is “directly connected” but also a case where it is “electrically connected” with another element arranged therebetween. In addition, when a certain portion is said to “include” a certain component, this does not mean excluding another component unless specifically stated otherwise but rather means further including another component.

Phrases such as “in an embodiment” appearing in various places in the disclosure do not necessarily all refer to the same embodiment.

An embodiment of the disclosure may be represented by functional block constructions and various processing operations. Some or all of these functional blocks may be implemented by various numbers of hardware and/or software constructions performing specific functions. For example, the functional blocks of the disclosure may be implemented by one or more microprocessors, or be implemented by circuit constructions for a predefined function. In addition, for example, the functional blocks of the disclosure may be implemented by various programming or scripting languages. The functional blocks may be implemented by algorithms that are executed by one or more processors. In addition, the disclosure may employ the prior art for the sake of electronic configuration, signal processing, and/or data processing, etc. Terms such as “mechanism,” “element,” “means,” and “construction” may be used broadly, and are not limited to mechanical and physical constructions.

In addition, connection lines or connection members between components illustrated in the drawings exemplarily merely represent functional connections and/or physical or circuit connections. In an actual device, connections between the components may be represented by replaceable or added various functional connections, physical connections, or circuit connections.

In this document, visual content may include content that an electronic device may visually display through a display. For example, the visual content may include content including at least one of a video, an image, a photograph, or a text. For example, the type of visual content may include at least one of video content, still image content, text content, or web content, but is not limited thereto.

In addition, a rendered image of visual content may be a result of rendering the visual content by an electronic device, and may refer to an image displayed on a display of the electronic device by rendering the visual content. In addition, for example, generating the rendered image of the visual content may mean rendering the visual content and displaying the rendered image on the display of the electronic device.

In addition, a rendering dimension of a rendered image may include a dimension of the rendered image that is displayed on the display of the electronic device through rendering. For example, the rendering dimension may include a two-dimensional (2D) rendering dimension and a three-dimensional (3D) rendering dimension. For example, the visual content may be rendered in two dimensions, whereby a 2D rendered image may be displayed on the display, and the visual content may be rendered in three dimensions, whereby a 3D rendered image may be displayed on the display.

In addition, a visual object may include an object included in a rendered image that is displayed on the display of the electronic device. The type of visual object may include a text object, a thing object, and a person object, for example, but is not limited thereto.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

The disclosure will be described in detail below with reference to the accompanying drawings.

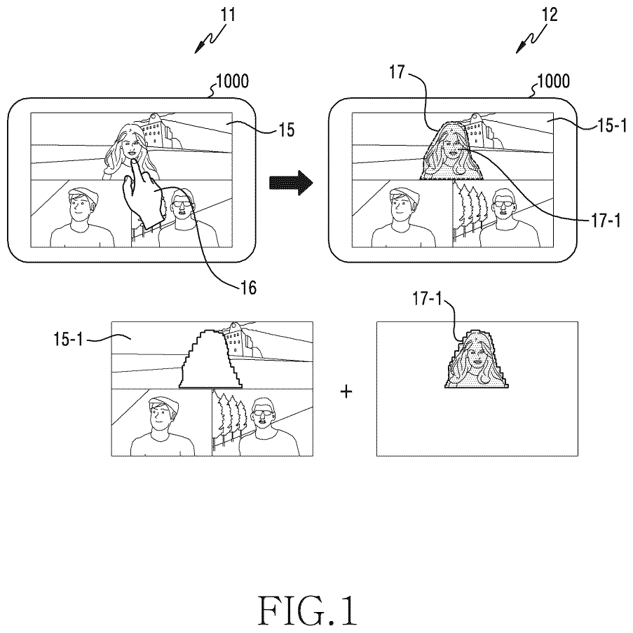

FIG. 1 is a diagram illustrating an overview of displaying visual content by replacing a portion of a rendered image of the visual content with a rendered image of another rendering dimension in an electronic device according to an embodiment of the disclosure.

Referring to FIG. 1, an electronic device 1000 may replace a portion of a rendered image of visual content with a rendered image having another rendering dimension, based on a user input that is received in the course of displaying the rendered image of the visual content. The electronic device 1000 may display a portion of visual content as a rendered image of a first rendering dimension and display another portion of the visual content as a rendered image of a second rendering dimension, based on a user input. In addition, the electronic device 1000 may display a portion of the visual content as the rendered image of the first rendering dimension and display another portion of the visual content as the rendered image of the second rendering dimension, based on a preset setting value related to the rendering dimension.

Referring to reference numeral 11 of FIG. 1, the electronic device 1000 may display visual content. For example, the electronic device 1000 may display the visual content on the display of the electronic device 1000 by displaying a two-dimensional first rendered image 15. In addition, the electronic device 1000 may receive a user input 16 for selecting a partial region 17 of the first rendered image 15 of the visual content.

Referring to reference numeral 12 of FIG. 1, the electronic device 1000 of an embodiment may select the partial region 17 of the first rendered image 15 of the visual content, based on a user input 16, and replace the partial region 17 of the first rendered image 15 with a three-dimensional second rendered image 17-1. For example, the electronic device 1000 may merge the first rendered image 15-1 from which the partial region 17 has been removed, with the second rendered image 17-1 for the partial region 17.

When displaying visual content, the electronic device 1000 may effectively switch and provide a two-dimensional rendered image and a three-dimensional rendered image, for areas of a display screen. In addition, while providing visual content in three dimensions, the electronic device 1000 may provide a high-resolution image for an area requiring detailed identification.

The electronic device 1000 may include a smart phone, a tablet PC, a personal computer (PC), a smart TV, a mobile phone, a personal digital assistant (PDA), a laptop computer, a media player, a micro server, a global positioning system (GPS) device, an e-book reader, a digital broadcasting terminal, a navigation device, a kiosk, an MP3 player, a digital camera, a home appliance, and other mobile or non-mobile computing devices, but is not limited thereto. In addition, the electronic device 1000 may include a wearable device such as a watch and glasses having a communication function and a data processing function. However, the electronic device 1000 is not limited thereto, and the electronic device 1000 may include all types of devices capable of displaying visual content.

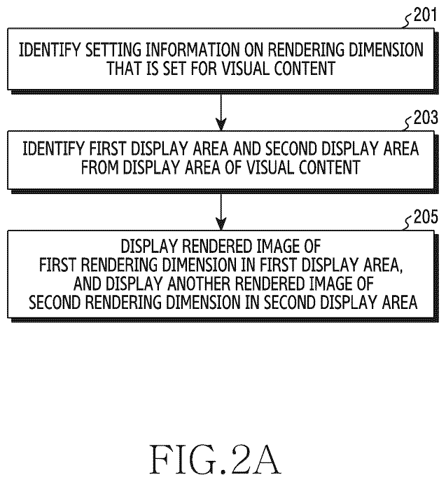

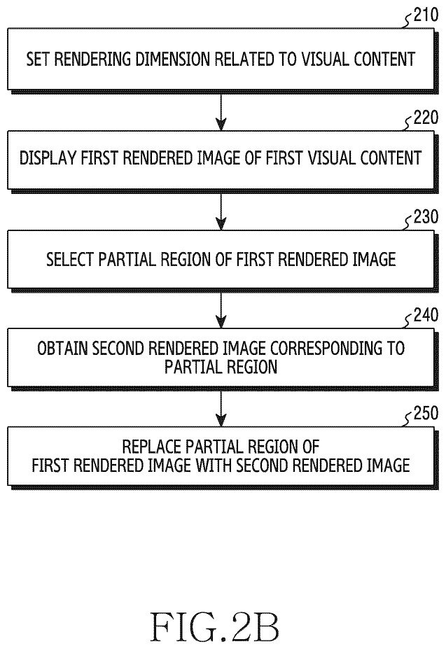

FIG. 2A is a flowchart illustrating a method of displaying different rendered images of visual content in an electronic device according to an embodiment of the disclosure.

Referring to FIG. 2A, in operation 201, an electronic device 1000 may identify setting information on a rendering dimension that is set for visual content. As a user input for executing visual content is received, the electronic device 1000 may obtain, from a memory, the setting information on the rendering dimension that is set for the visual content. For example, when a user input for executing an application for displaying visual content is received, or when a user input for selecting visual content in order to display the visual content is received, the electronic device 1000 may extract, from the memory, the setting information on the rendering dimension that is set for the visual content.

The setting information on the rendering dimension that is set for the visual content may include information on areas where a rendered image is to be displayed in a first rendering dimension and/or a second rendering dimension, among display areas where the visual content is displayed on a screen of the electronic device 1000. For example, the setting information may include information on a first display area corresponding to the first rendering dimension and a second display area corresponding to the second rendering dimension, among the display areas where the visual content is displayed on the screen of the electronic device 1000. The first rendering dimension and the second rendering dimension may be different rendering dimensions. For example, the first rendering dimension may include a two-dimensional (2D) rendering dimension, and the second rendering dimension may include a three-dimensional (3D) rendering dimension. Or, for example, the first rendering dimension may include a 3D rendering dimension, and the second rendering dimension may include a 2D rendering dimension.

The setting information may include information on a rendering dimension that is set for visual content by type of visual content. For example, the type of visual content may include at least one of video content, still image content, text content, or web content, but is not limited thereto. In addition, the rendering dimension may include, for example, a 2D rendering dimension and a 3D rendering dimension.

The setting information may include information on a rendering dimension that is set for a visual object by type of visual object included in visual content. The type of visual object may include, for example, a text object, a thing object, and a person object, but is not limited thereto.

The electronic device 1000 may include information on a rendering dimension that is set for an application by type of application displaying visual content or by application. The type of application may include a video playback application, a gallery application, a video conferencing application, and a message application, but is not limited thereto. In addition, for example, a two-dimensional rendered image may be set to be displayed for an execution screen of a keyboard application, an execution screen of a video search application, an execution screen of a web browser application, an execution screen of a chat application, and an execution screen of a calculator application, but is not limited thereto.

In operation 203, the electronic device 1000 may identify a first display area and a second display area among display areas of visual content. The electronic device 1000 may identify the first display area corresponding to the first rendering dimension among the display areas of the visual content, based on the setting information. In addition, the electronic device 1000 may identify the second display area corresponding to the second rendering dimension among the display areas of the visual content, based on the setting information. For example, the first display area may include a partial region of the display area of the visual content, and the second display area may include the remaining area of the display area of the visual content, but are not limited thereto. In addition, for example, when the visual content is movie video content, an area including a subtitle may include the second display area having the 2D rendering dimension, and an area excluding the subtitle may include the first display area having the 3D rendering dimension.

In operation 205, the electronic device 1000 may display a rendered image of the first rendering dimension in the first display area, and display another rendered image of the second rendering dimension in the second display area. The electronic device 1000 may display a rendered image of the first rendering dimension and another rendered image of the second rendering dimension, together.

The electronic device 1000 may merge a rendered image of the first rendering dimension to be displayed in the first display area, with a rendered image of the second rendering dimension to be displayed in the second display area. In addition, the electronic device 1000 may display the merged rendered image on a display of the electronic device 1000.

For example, when a human face is identified as the second display area and the remaining area is identified as the first display area, the electronic device 1000 may merge a three-dimensional rendered image including the human face with a two-dimensional rendered image for an area excluding the human face.

For example, the electronic device 1000 may identify a coordinate of the first display area to be rendered in the first rendering dimension and a coordinate of the second display area to be rendered in the second rendering dimension, in order to render visual content. In addition, based on the identified coordinates, the electronic device 1000 may render a portion of the visual content corresponding to the first display area in the first rendering dimension, and may render a portion of the visual content corresponding to the second display area in the second rendering dimension. Accordingly, the electronic device 1000 may display a rendered image of the first rendering dimension and a rendered image of the second rendering dimension, together. In this case, the electronic device 1000 may correct at least one of an image quality, color, or brightness of the rendered image of the first rendering dimension and the rendered image of the second rendering dimension.

FIG. 2B is a flowchart illustrating a method of replacing a portion of a rendered image of visual content with a rendered image of another rendering dimension in an electronic device according to an embodiment of the disclosure.

Referring to FIG. 2B, in operation 210, the electronic device 1000 may set a rendering dimension related to visual content. The electronic device 1000 may set a rendering dimension of a rendered image of the visual content.

The electronic device 1000 may set a rendering dimension for visual content by type of visual content. For example, the type of visual content may include at least one of video content, still image content, text content, or web content, but is not limited thereto. In addition, the rendering dimension may include, for example, a 2D rendering dimension and a 3D rendering dimension. In case where a rendering dimension for visual content of an embodiment is set, when the electronic device 1000 displays a rendered image of the visual content, the electronic device 1000 may display the rendered image of the set rendering dimension on a screen of the electronic device 1000.

The electronic device 1000 may set a rendering dimension for a visual object by type of visual object included in visual content. The type of visual object may include, for example, a text object, a thing object, and a person object, but is not limited thereto. In case where a rendering dimension for a visual object of an embodiment is set, when the electronic device 1000 displays a rendered image of visual content including the visual object, the electronic device 1000 may display the rendered image of the set rendering dimension for the visual object on the screen of the electronic device 1000.

The electronic device 1000 may set a rendering dimension for an application by type of application displaying visual content or by application. The type of application may include a video playback application, a gallery application, a video conferencing application, and a message application, for example, but is not limited thereto. In addition, for example, a two-dimensional rendered image may be set to be displayed for an execution screen of a keyboard application, an execution screen of a video search application, an execution screen of a web browser application, an execution screen of a chat application, and an execution screen of a calculator application, but is not limited thereto. In case where a rendering dimension for an application of an embodiment is set, when the electronic device 1000 displays visual content through the application, the electronic device 1000 may display a rendered image of the set rendering dimension on the screen of the electronic device 1000.

The electronic device 1000 may display a graphical user interface (GUI) for setting a rendering dimension related to visual content, and may set a rendering dimension related to visual content, based on a user input to the GUI.

In addition, for example, the electronic device 1000 may add a software code partially allowing the processing of two-dimensional rendering and three-dimensional rendering for visual content, to a file defining a screen of the visual content, based on a rendering dimension that is set for the visual content.

A target that is to be displayed as a rendered image having a two-dimensional rendering dimension may be managed as a separate black list. For example, an execution screen of an application providing a keyboard function may be managed as the target that is to be displayed as the rendered image having the two-dimensional rendering dimension. In addition, for example, an execution screen of a text-input-based application such as a chat application, a note application, and a calculator application may be managed as the target that is to be displayed as the rendered image having the two-dimensional rendering dimension. In addition, for example, a search window in a screen providing a search service may be managed as the target that is to be displayed as the rendered image having the two-dimensional rendering dimension.

In addition, for example, the electronic device 1000 may manage a subtitle portion of video content as the target that is to be displayed as the rendered image having the two-dimensional rendering dimension, by using an algorithm of recognizing a text within visual content.

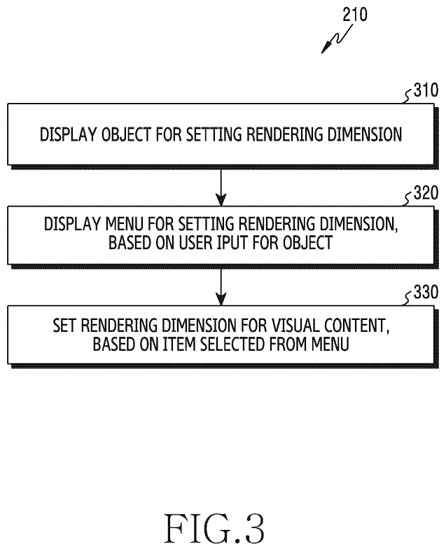

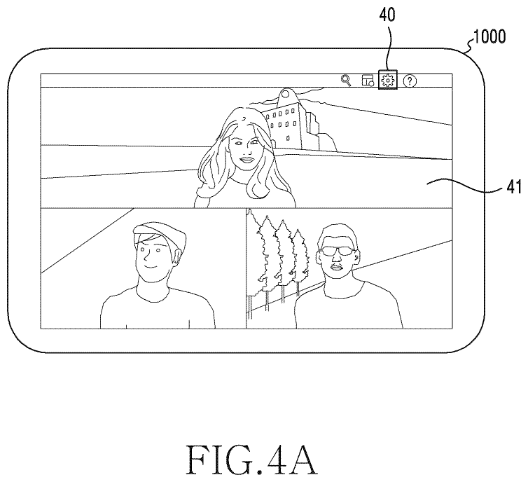

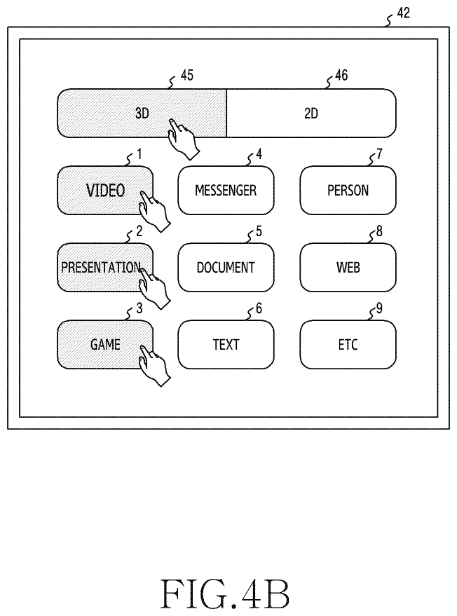

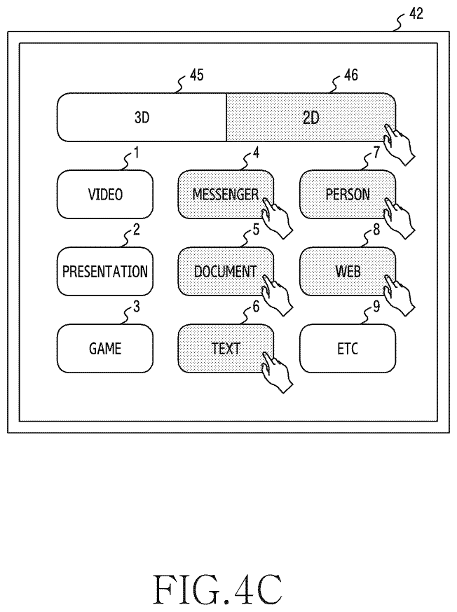

A method of setting a rendering dimension related to visual content in the electronic device 1000 of an embodiment is described below in more detail with respect to FIGS. 3 and 4A to 4C.

In operation 220, the electronic device 1000 may display a first rendered image of a first visual content. The electronic device 1000 of an embodiment may receive a user input for displaying the first visual content, and in response to the received user input, may display the first rendered image of the first visual content. The first rendered image may include a rendered image having a first rendering dimension. The first rendering dimension may include two dimensions or three dimensions.

The electronic device 1000 may identify a rendering dimension that is set for a first visual content, and display a first rendered image of the identified rendering dimension. The electronic device 1000 may identify a rendering dimension that is set for an application that displays a first visual content, and display a first rendered image of the identified rendering dimension. The electronic device 1000 may display a first rendered image of a first visual content, but display a rendered image of a rendering dimension that is separately set for a specific visual object within the first visual content.

For example, when a first visual content is a photographic image and a rendering dimension for the photographic image is set as two dimensions, the electronic device 1000 may generate and display a first rendered image having the two dimensions, based on data of the photographic image.

In operation 230, the electronic device 1000 of an embodiment may select a partial region of the first rendered image. The electronic device 1000 may receive a user input for selecting the partial region of the first rendered image, and based on the received user input, may select the partial region of the first rendered image. In this case, the user input for selecting the partial region of the first rendered image may include a user input for changing a rendering dimension of the partial region of the first rendered image.

For example, the user input for selecting the partial region of the first rendered image may include a user's touch input. For example, the user input for selecting the partial region of the first rendered image may include a user input for dragging to select the partial region of the first rendered image. For example, the user input for selecting the partial region of the first rendered image may include a user input for touching a specific visual object within the first rendered image.

For example, the user input for selecting the partial region of the first rendered image may include a user's gesture input. For example, the user input for selecting the partial region of the first rendered image may include a gesture input for moving a user's hand in a specific shape in a position close to the partial region of the first rendered image. In this case, the user's gesture input may be captured by a camera (not shown) of the electronic device 1000 and be identified by the electronic device 1000.

For example, the user input for selecting the partial region of the first rendered image may include a user's gaze input. For example, the user input for selecting the partial region of the first rendered image may include a user input for gazing at the partial region of the first rendered image for a specified period of time or longer. For example, the user input for selecting the partial region of the first rendered image may include a user input for gazing at a specific visual object within the first rendered image for a specified period of time or longer. In this case, the user's gaze input may be captured by the camera (not shown) of the electronic device 1000 and be identified by the electronic device 1000.

For example, when the first rendered image of the first visual content includes a human face, the electronic device 1000 may receive a user input for selecting the human face as the partial region of the first rendered image.

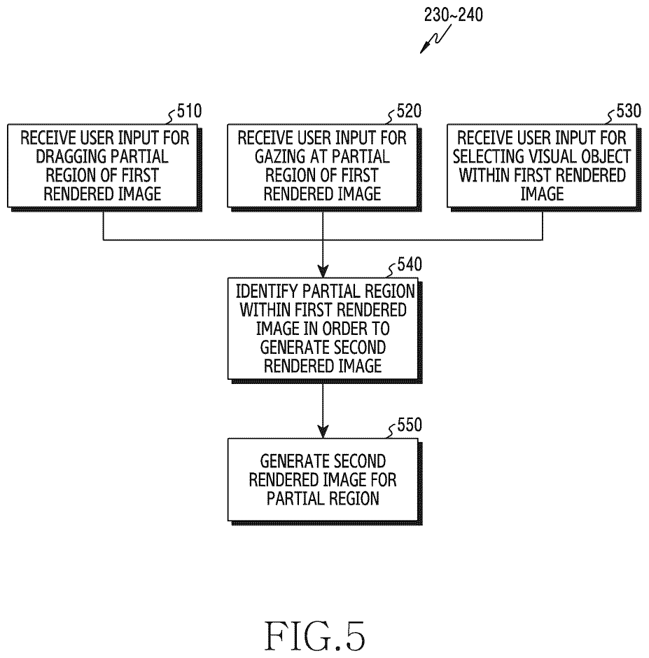

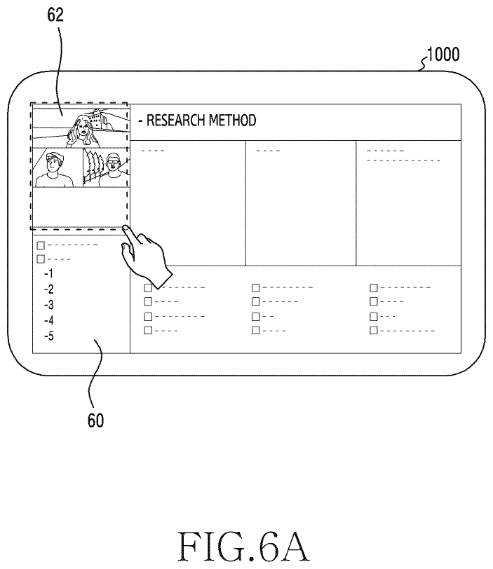

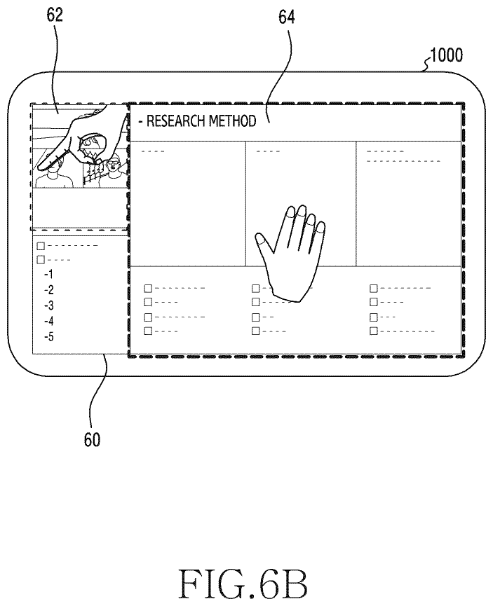

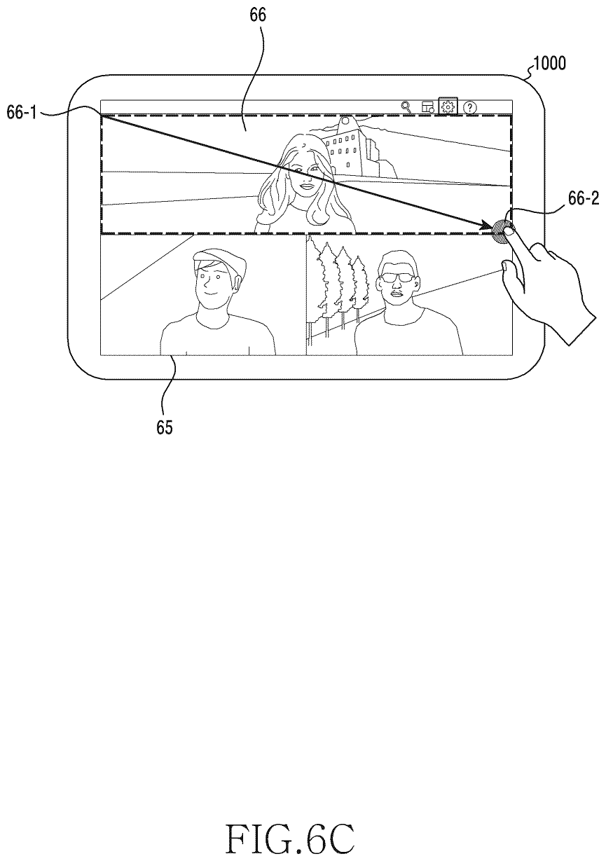

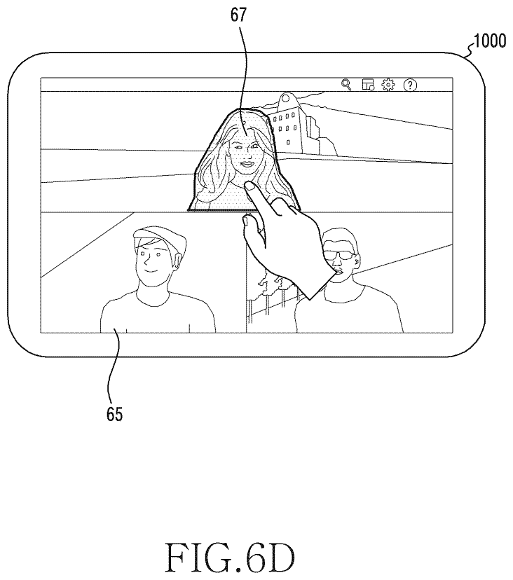

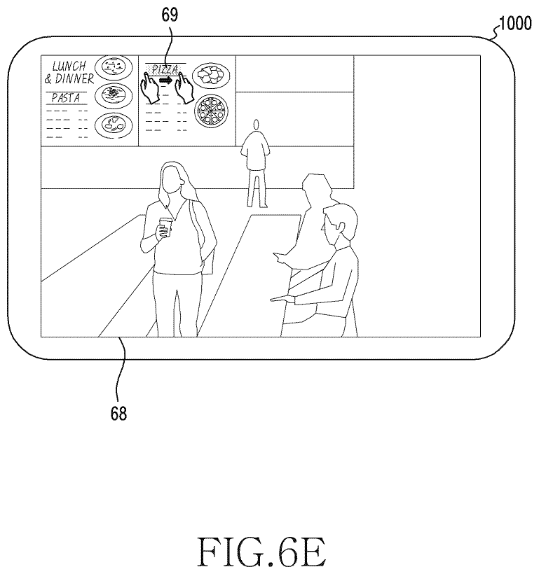

The user input for selecting the partial region of the first rendered image of the visual content of an embodiment is described below in more detail with respect to FIGS. 5 and 6A to 6E.

In operation 240, the electronic device 1000 may obtain a second rendered image corresponding to the partial region of the first rendered image. The electronic device 1000 may generate the second rendered image corresponding to the partial region of the first rendered image of the visual content wherein the second rendered image has a second rendering dimension different from the first rendering dimension. The electronic device 1000 may identify the first rendering dimension of the first rendered image, and generate the second rendered image wherein the second rendered image has the second rendering dimension different from the first rendering dimension, based on image data corresponding to the partial region of the first rendered image of the visual content.

For example, in case where a human face is selected as a partial region within a two-dimensional first rendered image, the electronic device 1000 may generate a second rendered image of the selected human face wherein the second rendered image has three dimensions, not two dimensions, based on image data of the selected human face.

In operation 250, the electronic device 1000 may replace the partial region of the first rendered image with the second rendered image. The electronic device 1000 may remove the partial region of the first rendered image. In addition, the electronic device 1000 may display the first rendered image from which the partial region has been removed, together with the second rendered image corresponding to the removed partial region, on a display of the electronic device 1000.

The electronic device 1000 may merge the first rendered image from which the partial region has been removed, with the second rendered image corresponding to the removed partial region. In addition, the electronic device 1000 may display the merged rendered image on the display of the electronic device 1000.

For example, when a human face is selected as a partial region within a two-dimensional first rendered image, the electronic device 1000 may merge the two-dimensional first rendered image from which the human face has been removed, with a three-dimensional second rendered image of the human face.

For example, the electronic device 1000 may identify a coordinate of an area to be rendered in a first rendering dimension and a coordinate of an area to be rendered in a second rendering dimension, in order to render visual content. In addition, based on the identified coordinates, the electronic device 1000 may render, in the first rendering dimension, a portion of visual content corresponding to the area to be rendered in the first rendering dimension, and render, in the second rendering dimension, a portion of visual content corresponding to the area to be rendered in the second rendering dimension. Accordingly, the electronic device 1000 may display the first rendered image of the first rendering dimension and the second rendered image of the second rendering dimension, together. In this case, the electronic device 1000 may correct at least one of an image quality, color, or brightness of the first rendered image and the second rendered image.

The electronic device 1000 may display a portion of visual content and another portion of the visual content in different rendering dimensions, and may improve the three-dimensionality and visibility of the displayed visual content. In addition, the electronic device 1000 may flexibly adjust the rendering dimension for the portion and another portion of the visual content, based on setting for the rendering dimension and/or a user input received in real time, and may reduce an eye fatigue of a user who sees the visual content.

In addition, although FIG. 2B describes that the partial region of the first rendered image of the first visual content is replaced with the second rendered image, it is not limited thereto. For example, based on a user input for selecting the partial region of the first rendered image, the selected partial region of the first rendered image may be also replaced with the second rendered image, while the first visual content is displayed through the first rendered image and another rendered image of a different rendering dimension.

FIG. 3 is a flowchart illustrating a method of setting a rendering dimension for visual content in an electronic device according to an embodiment of the disclosure.

Referring to FIG. 3, operations 310 to 330 of FIG. 3 may correspond to operation 210 of FIGS. 2A and 2B.

In operation 310, the electronic device 1000 may display an object for setting a rendering dimension on a display of the electronic device 1000. For example, the electronic device 1000 may display an icon for setting a rendering dimension of visual content. For example, the electronic device 1000 may display an icon for setting a rendering dimension of visual content, in a tray displayed at the top of the display, but is not limited thereto.

In operation 320, the electronic device 1000 may display a menu for setting a rendering dimension, based on a user input for the object. For example, when the icon for setting the rendering dimension of the visual content is selected, the electronic device 1000 may display the menu for setting the rendering dimension.

For example, the menu for setting the rendering dimension may include buttons for selecting the rendering dimension, items indicating the type of visual content, items indicating the type of visual object, and items indicating the type of application, but is not limited thereto.

In operation 330, the electronic device 1000 may set a rendering dimension for visual content, based on the item selected from the menu. According to an embodiment, the electronic device 1000 may set the rendering dimension for the visual content, based on a user input for the menu.

For example, by selecting one of the buttons for selecting the rendering dimension, and then receiving a user input for selecting at least one of the items indicating the type of visual content, the items indicating the type of visual object, and the items indicating the type of application, the electronic device 1000 may select items of visual content for displaying a rendered image of the selected rendering dimension.

An example of setting a rendering dimension based on a user input in the electronic device 1000 of an embodiment is described below in more detail with respect to FIGS. 4A to 4C.

FIG. 4A is a diagram illustrating an example of a setting icon for setting a rendering dimension of visual content according to an embodiment of the disclosure.

Referring to FIG. 4A, the electronic device 1000 may display a setting icon 40 for setting a rendering dimension for visual content, at a top portion of a display of the electronic device 1000. For example, the setting icon 40 may be displayed in a tray displayed at a top of the display of the electronic device 1000, regardless of a window 41 where a rendered image of the visual content is displayed. In addition, for example, a user may select the setting icon 40 in order to set a rendering dimension of a rendered image of visual content.

FIG. 4B is a diagram illustrating an example of setting a three-dimensional rendering dimension for visual content through a menu for setting a rendering dimension of visual content according to an embodiment of the disclosure.

Referring to FIG. 4B, an electronic device 1000 may display a menu 42 for setting a rendering dimension of visual content, when the setting icon 40 of FIG. 4A is selected.

According to an embodiment, the menu 42 for setting the rendering dimension of the visual content may include buttons 45 and 46 for selecting a rendering dimension related to visual content. In addition, the menu 42 may include items 1, 2, 3, 4, 5, 6, 7, 8, and 9 for selecting a target to which the selected rendering dimension is to be applied.

For example, the buttons 45 and 46 for selecting the rendering dimension related to the visual content may include a button 45 for selecting a three-dimensional rendering dimension and a button 46 for selecting a two-dimensional rendering dimension.

For example, the items 1, 2, 3, 4, 5, 6, 7, 8, and 9 for selecting the target to which the selected rendering dimension is to be applied may include buttons 1, 2, and 3 indicating the type of visual content, buttons 4 and 5 indicating the type of application for displaying visual content, and buttons 6, 7, and 8 indicating the type of visual object.

When one of the buttons 45 and 46 for selecting the rendering dimension related to the visual content is selected, and at least one of the items 1, 2, 3, 4, 5, 6, 7, 8, and 9 for selecting the target to which the selected rendering dimension is to be applied is selected, the electronic device 1000 may apply the selected rendering dimension to visual content and/or visual object corresponding to the selected item.

For example, in case where a user selects the buttons 1, 2, and 3 after selecting the button 45, the electronic device 1000 may set a rendering dimension for visual content whose type is a video, a presentation, or a game, wherein a three-dimensional rendered image is displayed.

FIG. 4C is a diagram illustrating an example of setting a two-dimensional rendering dimension for visual content through a menu for setting a rendering dimension of visual content according to an embodiment of the disclosure.

Referring to FIG. 4C, when one of the buttons 45 and 46 for selecting a rendering dimension related to visual content is selected, and at least one of items 1, 2, 3, 4, 5, 6, 7, 8, and 9 for selecting a target to which the selected rendering dimension is to be applied is selected, an electronic device 1000 may apply the selected rendering dimension to visual content and/or visual object corresponding to the selected item.

For example, in case where a user selects the buttons 4, 5, 6, 7, and 8 after selecting the button 46, when the type of visual content is a web page, the type of application displaying visual content is a messenger application or document application, or the visual object is a text or person, the electronic device 1000 may apply a two-dimensional rendering dimension to the visual content and/or the visual object.

FIG. 5 is a flowchart illustrating a method of selecting a partial region of a rendered image in an electronic device according to an embodiment of the disclosure.

Referring to FIG. 5, operations 510 to 550 of FIG. 5 may correspond to operations 230 and 240 of FIGS. 2A and 2B.

In operation 510, the electronic device 1000 may receive a user input for dragging a partial region of a first rendered image. The electronic device 1000 may receive a drag input from a user for changing a rendering dimension for a partial region of a first rendered image of a first visual content. For example, the electronic device 1000 may receive a drag input for specifying diagonal vertices of a partial region of a square, in the entire region of the first rendered image. For example, the electronic device 1000 may receive a drag input for drawing a border of a partial region, in the entire region of the first rendered image. However, the drag input for selecting the partial region is not limited thereto.

In operation 520, the electronic device 1000 may receive a user input for gazing at a partial region of a first rendered image. For example, in order to change a partial region of a first rendered image of a first visual content, the user may gaze at the partial region of the first rendered image, and by capturing user's eyes, the electronic device 1000 may identify a gaze input that the user gazes at the partial region of the first rendered image.

In operation 530, the electronic device 1000 may receive a user input for selecting a visual object within a first rendered image. For example, the electronic device 1000 may receive a user input for long-touching a visual object within a first rendered image. For example, the electronic device 1000 may receive a user input for gazing at a visual object within a first rendered image for a specified period of time or longer.

In operation 540, the electronic device 1000 may identify the partial region selected from the first rendered image in order to generate a second rendered image. For example, when the electronic device 1000 receives the user input for dragging the partial region of the first rendered image, the electronic device 1000 may identify a partial region in which a rendering dimension is to be changed within the first rendered image, based on a trajectory of the drag input.

For example, when the electronic device 1000 receives the user input for gazing at the partial region of the first rendered image, the electronic device 1000 may identify a certain partial region including a position gazed at by the user, as the partial region in which the rendering dimension is to be changed, based on the position gazed at by the user. In this case, the electronic device 1000 may, for example, select content including the gazed position as the partial region, or select a window including the gazed position as the partial region, but is not limited thereto.

For example, when the electronic device 1000 receives the user input for selecting the visual object within the first rendered image, the electronic device 1000 may identify a region in which the visual object selected by the user is positioned, as the partial region.

In operation 550, the electronic device 1000 may generate a second rendered image for the partial region. The electronic device 1000 may generate the second rendered image wherein the second rendered image for the partial region has a second rendering dimension different from a first rendering dimension of the first rendered image. For example, the electronic device 1000 may extract data about the partial region from data of the visual content, and based on the extracted data, may generate the second rendered image having the second rendering dimension.

FIG. 6A is a diagram illustrating an example of a user input for selecting a partial region of a first rendered image according to an embodiment of the disclosure.

Referring to FIG. 6A, the electronic device 1000 may display a first rendered image 60 of visual content, and may receive a user input for selecting a partial region 62 of the first rendered image 60. For example, the electronic device 1000 may receive a user input for specifying a border of the partial region 62 in the first rendered image 60 and long-touching the partial region 62. In this case, the electronic device 1000 may identify that a rendering dimension of the partial region 62 is changed in response to the user input being received.

FIG. 6B is a diagram illustrating an example of a gesture input for selecting a partial region of a first rendered image according to an embodiment of the disclosure.

Referring to FIG. 6B, the electronic device 1000 may display a first rendered image 60 of visual content, and may receive a user input for selecting a partial region 62 of the first rendered image 60. For example, the electronic device 1000 may receive a user input for specifying a border of the partial region 62 in the first rendered image 60 and closing a hand on the partial region 62. In this case, the electronic device 1000 may identify the user input for closing the hand by using a camera, and determine a rendering dimension of the partial region 62 as three dimensions.

For example, the electronic device 1000 may receive a user input for specifying a border of another partial region 64 in the first rendered image 60 and opening a hand on the partial region 64. In this case, the electronic device 1000 may identify the user input for opening the hand by using the camera, and may determine a rendering dimension of the partial region 64 as two dimensions.

FIG. 6C is a diagram illustrating an example of a drag input for selecting a partial region of a first rendered image according to an embodiment of the disclosure.

Referring to FIG. 6C, the electronic device 1000 may display a first rendered image 65 of visual content, and may receive a user input for selecting a partial region 66 of the first rendered image 65. For example, the electronic device 1000 may receive a drag input from a first point 66-1 to a second point 66-2 in order to select the partial region 66 of the first rendered image 65. As the drag input is received, the electronic device 1000 may identify, as the partial region 66, a rectangular region having the first point 66-1 and the second point 66-2 as opposite vertices.

FIG. 6D is a diagram illustrating an example of a user input for selecting, as a partial region, a visual object within a first rendered image according to an embodiment of the disclosure.

Referring to FIG. 6D, the electronic device 1000 may display a first rendered image 65 of visual content, and may receive a user input for selecting a visual object 67 within the first rendered image 65, as a partial region. For example, the electronic device 1000 may receive a user input for long-touching a specific person in the first rendered image 65. In this case, the electronic device 1000 may identify a region where the person, which is the visual object 67 selected by the long touch, is displayed, as the partial region.

In this case, for example, the electronic device 1000 may identify the visual object 67 selected by a user, by using an object recognition function for an image. The electronic device 1000 may identify visual objects within visual content, by using an artificial intelligence model trained for object recognition, and may identify the visual object 67 selected by a user among the identified visual objects, based on a position of the user input (e.g., long-touch input).

FIG. 6E is a diagram illustrating an example of a user input for selecting a partial region of a first rendered image according to an embodiment of the disclosure.

Referring to FIG. 6E, the electronic device 1000 may display a first rendered image 68 of video content, and the first rendered image 68 may have a three-dimensional rendering dimension. In this case, for example, characters within the first rendered image 68 may have poor readability and thus, a user may input a touch input for rubbing the characters within the first rendered image 68, in order to change a rendering dimension of a region where the characters are positioned in the first rendered image 68 into two dimensions. When the touch input for rubbing the characters is received, the electronic device 1000 may select a region touched by the user as a partial region 69, and display a two-dimensional rendered image for the selected partial region 69.

The electronic device 1000 may recognize a text in a region included in or adjacent to a touch input region, based on the touch input for rubbing the characters, and may also select the region including the recognized text as the partial region 69. Accordingly, for example, even when the touch input for rubbing is larger than or smaller than a region where the characters are positioned, the electronic device 1000 may effectively select the region including the characters, and accordingly, may improve a readability and resolution of the characters within visual content.

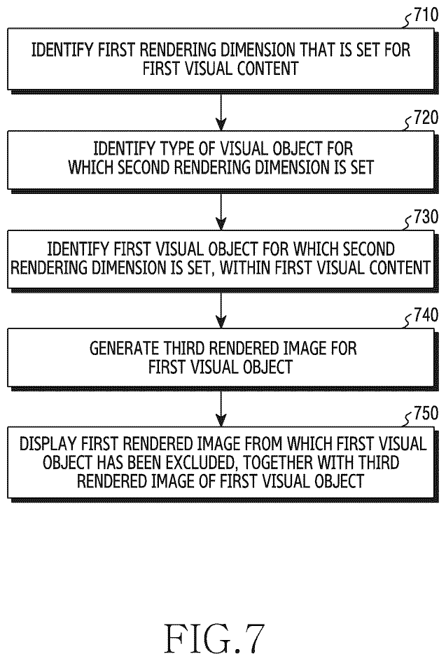

FIG. 7 is a flowchart illustrating a method of displaying rendered images of different dimensions, based on setting regarding a rendering dimension, in an electronic device according to an embodiment of the disclosure.

Referring to FIG. 7, operations 710 to 750 of FIG. 7 may correspond to operation 220 of FIGS. 2A and 2B. In addition, in FIG. 7, rendered images of different dimensions may be displayed based on a preset setting value for a rendering dimension, without a user input for changing the rendering dimension.

In operation 710, the electronic device 1000 may identify a first rendering dimension that is set for a first visual content. A rendering dimension for visual content may be set by type of visual content. In this case, the electronic device 1000 may identify the type of first visual content, and identify the first rendering dimension corresponding to the type of first visual content.

A rendering dimension may be set for an application. In this case, the electronic device 1000 may identify an application that executes a first visual content, and identify a first rendering dimension corresponding to the application.

In operation 720, the electronic device 1000 may identify the type of visual object for which a second rendering dimension is set. A rendering dimension for a visual object may be set by type of visual object included in visual content. In this case, the electronic device 1000 may identify the types of visual objects for which the second rendering dimension is set.

In operation 730, the electronic device 1000 may identify, within the first visual content, a first visual object for which the second rendering dimension is set. The electronic device 1000 may identify the first visual object for which the second rendering dimension different from the first rendering dimension is set, among visual objects included within a first rendered image. For example, by comparing the types of visual objects for which the second rendering dimension is set with the visual objects within the first rendered image, the electronic device 1000 may identify the first visual object for which the second rendering dimension is set, among the visual objects within the first rendered image. For example, the electronic device 1000 may identify a subtitle for which a two-dimensional rendering dimension is set, within the first rendered image.

In operation 740, the electronic device 1000 may generate a third rendered image for the first visual object. The electronic device 1000 may generate the third rendered image of the first visual object wherein the third rendered image has the second rendering dimension. For example, the electronic device 1000 may identify data about the first visual object from data of the first visual content, and generate the third rendered image having the second rendering dimension, based on the identified data.

In operation 750, the electronic device 1000 may display the first rendered image from which the first visual object has been excluded, together with the third rendered image of the first visual object. The electronic device 1000 may merge the first rendered image from which the first visual object has been excluded, with the third rendered image of the first visual object. In addition, the electronic device 1000 may display the merged rendered image on a display of the electronic device 1000.

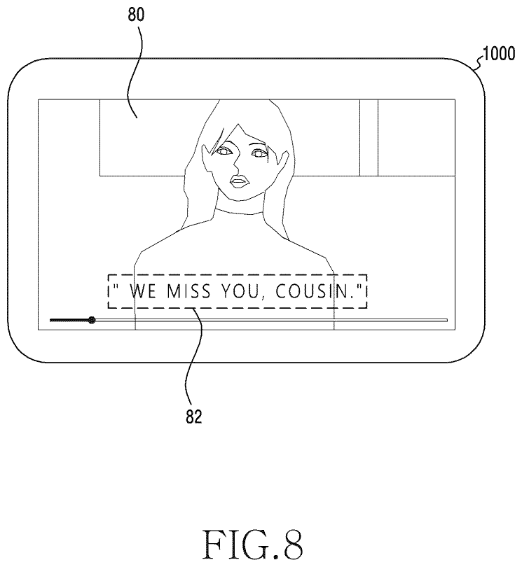

FIG. 8 is a diagram illustrating an example of displaying rendered images of different dimensions, based on a setting value regarding a rendering dimension, in an electronic device according to an embodiment of the disclosure.

Referring to FIG. 8, the electronic device 1000 may display a rendered image of video content through a video application. For example, when the video application is executed, and a user input for playing the video content is received through the video application, the electronic device 1000 may display the video content.

The electronic device 1000 may identify setting regarding a rendering dimension related to video content, in order to display the video content. For example, when a three-dimensional rendering dimension is set for video content, or the three-dimensional rendering dimension is set for a video application, the electronic device 1000 may identify that a rendered image of the video content is to be displayed as a three-dimensional rendered image. In addition, the electronic device 1000 may identify a subtitle in the video content, and identify that the subtitle of the video content is to be displayed as a two-dimensional rendered image.

In addition, for example, the electronic device 1000 may generate a three-dimensional rendered image 80 for a portion of video content excluding a subtitle, based on data of the video content. In addition, the electronic device 1000 may generate a two-dimensional rendered image 82 for a subtitle portion of the video content, based on the data of the video content. In addition, the electronic device 1000 may merge the three-dimensional rendered image 80 with the two-dimensional rendered image 82, and display the merged rendered image.

In addition, for example, the electronic device 1000 may identify subtitle frames from video file frames, and specify, as a subtitle area, an area where a subtitle is positioned, from the identified frames. For example, the electronic device 1000 may specify, as the subtitle area, a lower area of a screen where the subtitle is mainly positioned, and adjust the specified subtitle area when a text is identified in an area other than the specified subtitle area. Accordingly, the electronic device 1000 may check whether there is a text in the subtitle area by using a text recognition algorithm (e.g., tesseract OCR) for the subtitle area of the video content, and display the two-dimensional rendered image 82 for the checked subtitle area.

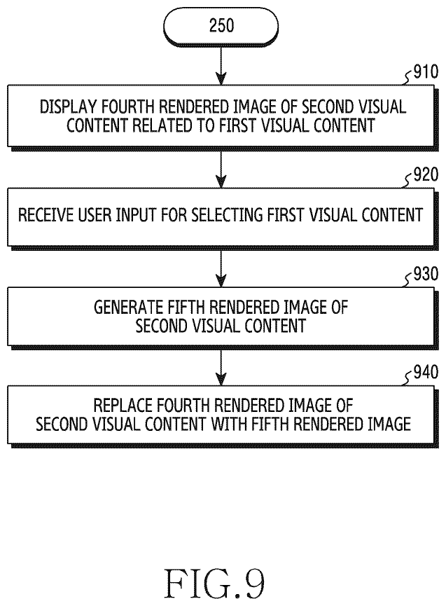

FIG. 9 is a flowchart illustrating a method of changing a rendering dimension of visual content, based on a user input for another visual content, in an electronic device according to an embodiment of the disclosure.

Referring to FIG. 9, operations 910 to 940 of FIG. 9 may be performed after operation 250 of FIGS. 2A and 2B, but are not limited thereto. Operations 910 to 940 of FIG. 9 may be also performed regardless of at least some of operations of FIGS. 2A and 2B.

In operation 910, the electronic device 1000 may display a fourth rendered image of a second visual content related to a first visual content. The electronic device 1000 may display the fourth rendered image of the second visual content, together with a first rendered image of the first visual content. According to an embodiment, the first visual content and the second visual content may be displayed through one application, but are not limited thereto. An application providing the first visual content may be different from an application providing the second visual content.

The second visual content related to the first visual content may include visual content providing detailed information related to the first visual content. For example, the first visual content may include visual content including a text describing an interior in a building, and the second visual content may include visual content including a photograph of the interior in the building.

A first rendering dimension of the first rendered image may be the same as or different from a fourth rendering dimension of the fourth rendered image. For example, the first rendered image may include a two-dimensional rendered image and the fourth rendered image may include a two-dimensional rendered image, but are not limited thereto.

In operation 920, the electronic device 1000 may receive a user input for selecting the first visual content. According to an embodiment, when the first visual content and the second visual content are displayed together, the electronic device 1000 may receive the user input for selecting the first visual content. For example, the user input for selecting the first visual content may include at least one of a touch input, a gaze input, or a gesture input, but is not limited thereto.

In operation 930, the electronic device 1000 may generate a fifth rendered image of the second visual content. The electronic device 1000 may generate the fifth rendered image of the second visual content in order to change a rendering dimension of the second visual content. In this case, a rendering dimension of the fourth rendered image of the second visual content may be different from a rendering dimension of the fifth rendered image of the second visual content. For example, when the fourth rendered image includes a two-dimensional rendered image, the electronic device 1000 may generate a three-dimensional fifth rendered image. The electronic device 1000 may generate the three-dimensional fifth rendered image, based on data of the second visual content.

In operation 940, the electronic device 1000 may replace the fourth rendered image of the second visual content with the fifth rendered image. According to an embodiment, the electronic device 1000 may stop displaying the fourth rendered image of the second visual content, and display the fifth rendered image of the second visual content instead of the fourth rendered image of the second visual content. Accordingly, the first rendered image of the first visual content and the fifth rendered image of the second visual content may be displayed together.

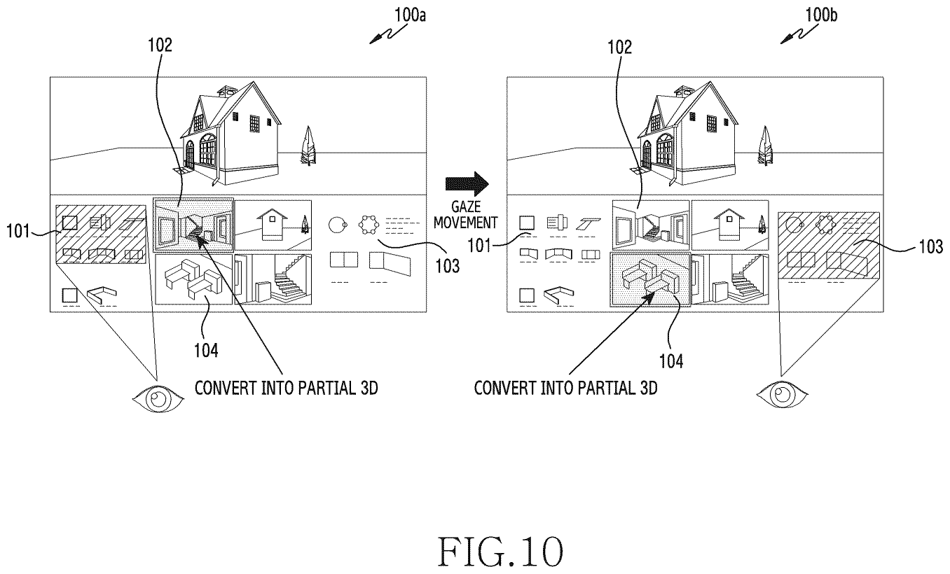

FIG. 10 is a diagram illustrating an example of changing a rendering dimension of visual content, based on a user input for another visual content, in an electronic device according to an embodiment of the disclosure.

Referring to FIG. 10, the electronic device 1000 may display rendered images of a first visual content 101, a second visual content 102, a third visual content 103, and a fourth visual content 104.

The first visual content 101 may be associated with the second visual content 102. For example, the rendered image of the first visual content 101 may provide first information describing an interior in a building, and the rendered image of the second visual content 102 may provide a photograph of the interior corresponding to the first information. In this case, the rendered image of the first visual content 101 and the rendered image of the second visual content 102 may include two-dimensional rendered images.

The third visual content 103 may be associated with the fourth visual content 104. For example, the rendered image of the third visual content 103 may provide second information describing an interior in a building, and the rendered image of the fourth visual content 104 may provide a photograph of the interior corresponding to the second information. In this case, the rendered image of the third visual content 103 and the rendered image of the fourth visual content 104 may include two-dimensional rendered images.

Referring to reference numeral 100a of FIG. 10, when a user gazes at the rendered image of the first visual content 101 for a specified period of time or longer, the electronic device 1000 may change the rendered image of the second visual content 102 into a three-dimensional rendered image. The electronic device 1000 may generate the three-dimensional rendered image wherein the rendered image of the second visual content 102 has three dimensions, based on data of the second visual content 102. In addition, the electronic device 1000 may replace the two-dimensional rendered image of the second visual content 102 with the three-dimensional rendered image.

Referring to reference numeral 100b of FIG. 10, the user may move a gaze on the first visual content 101 to the rendered image of the third visual content 103. As the user's gaze moves, the three-dimensional rendered image of the second visual content 102 may be changed to a two-dimensional rendered image.

In addition, for example, when the user gazes at the rendered image of the third visual content 103 for a specified period of time or longer, the electronic device 1000 may change the rendered image of the fourth visual content 104 into a three-dimensional rendered image. The electronic device 1000 may generate the three-dimensional rendered image wherein the rendered image of the fourth visual content 104 has three dimensions, based on data of the fourth visual content 104. In addition, the electronic device 1000 may change the two-dimensional rendered image of the fourth visual content 104 into the three-dimensional rendered image.

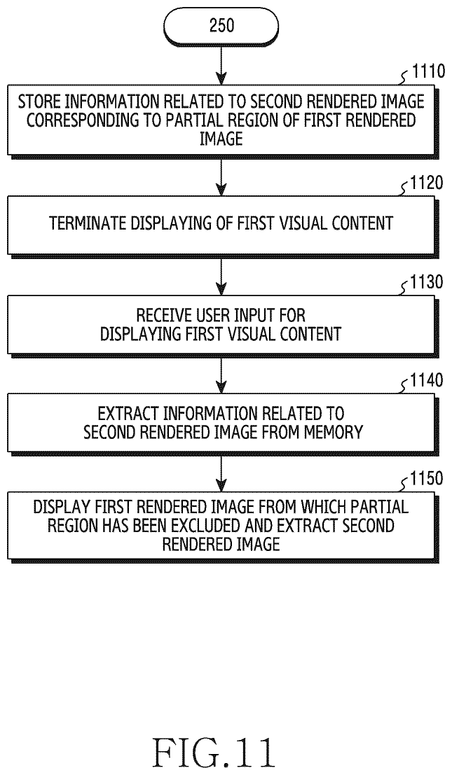

FIG. 11 is a flowchart illustrating a method of storing information related to a rendered image and changing a dimension of a displayed rendered image by using the stored rendered image in an electronic device according to an embodiment of the disclosure.

Referring to FIG. 11, operations 1110 to 1150 of FIG. 11 may be performed after operation 250 of FIGS. 2A and 2B, but are not limited thereto. Operations 1110 to 1150 of FIG. 11 may be also performed regardless of at least some of operations of FIGS. 2A and 2B.

In operation 1110, the electronic device 1000 may store information related to a second rendered image corresponding to a partial region of a first rendered image. The electronic device 1000 may generate the second rendered image corresponding to the partial region of the first rendered image wherein the second rendered image has a second rendering dimension, and may store the information related to the generated second rendered image in a memory. The information related to the second rendered image of the second rendering dimension may include, for example, the second rendered image generated to have the second rendering dimension. The information related to the second rendered image of the second rendering dimension may include, for example, metadata required for rendering the second rendered image of the second rendering dimension, but is not limited thereto. The metadata may include, for example, a coordinate value for identifying a partial region of a first visual content, data corresponding to the partial region in first visual content data, an identification value of the second rendering dimension, and a setting value for generating the second rendered image in the second rendering dimension.

In relation to a file defining a screen construction of visual content displayed on a display of the electronic device 1000, the information related to the second rendered image of the second rendering dimension may be stored as metadata. For example, in the file defining the screen construction of the visual content displayed on the display of the electronic device 1000, a coordinate of a location where the first rendered image of the first rendering dimension is to be displayed, and a coordinate of a location where the second rendered image of the second rendering dimension is to be displayed may be set, but are not limited thereto.

In operation 1120, the electronic device 1000 may terminate the displaying of a first visual content. For example, when the playback of the first visual content is completed, the displaying of the first visual content may be terminated. Or, for example, as a user input for terminating the playback of the first visual content is received, the displaying of the first visual content may be terminated.

In operation 1130, the electronic device 1000 may receive a user input for displaying the first visual content. After the displaying of the first visual content is terminated in operation 1120, the electronic device 1000 may receive a user input for displaying the first visual content again.

In operation 1140, the electronic device 1000 may extract the information related to the second rendered image from the memory. Before displaying the first visual content again, the electronic device 1000 may search for information related to the second rendered image for a partial region of the first visual content, and extract the information related to the second rendered image from the memory.

In operation 1150, the electronic device 1000 may display the first rendered image from which the partial region has been excluded, and the extracted second rendered image. While displaying the first rendered image of the first rendering dimension, the electronic device 1000 may display the second rendered image having the second rendering dimension in the partial region. By displaying the second rendered image having the second rendering dimension, based on the previously stored information related to the second rendered image, the electronic device 1000 may efficiently display the first rendered image and the second rendered image having different rendering dimensions for the first visual content, together.

A real-time conversion method may be provided to support 2D video content. For example, when a 2D video is delivered to a video playback application, the electronic device 1000 may convert the 2D video into a 3D video through real-time analysis. At this time, the electronic device 1000 may cache conversion data of the 3D video for the input 2D video, as data generated in a conversion process, and may store the cached data in a storage device of the electronic device 1000. The stored data may be stored to be used for 3D conversion in a situation where the 2D video is re-executed, and may include metadata that enables 3D conversion by using only the stored data. The video playback application of the electronic device 1000 may convert a specific region of the 2D video into the 3D video at a specific point of time, without real-time analysis of the 2D video through 3D conversion data. Accordingly, in a situation where re-execution of the previously executed 2D video is requested, when there is the 3D conversion data usable for the 2D video to be re-executed, the electronic device 1000 may synthesize the 3D conversion data with the 2D video and convert the 2D video into the 3D video.

According to an embodiment of the disclosure, a new type of video file format may be provided. The video file format may include 2D video information and 3D conversion data. When a file of the video file format is executed, the video playback application of the electronic device 1000 may play a 2D video as a 3D video by using the 3D conversion data within the file. For example, the 3D conversion data may include data about which region of the 2D video is to be converted into which 3D form at a specific point of time, and may include additional information such as a subtitle.

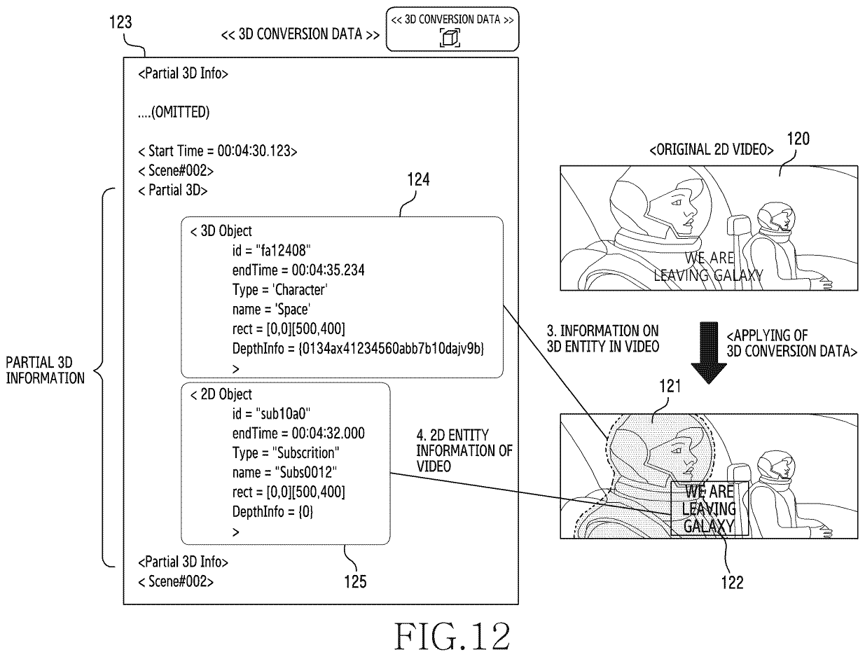

FIG. 12 is a diagram illustrating an example of information related to a rendered image of visual content according to an embodiment of the disclosure.

Referring to FIG. 12, the electronic device 1000 may identify a first partial region 121 corresponding to a person and a second partial region 122 corresponding to a subtitle, in the original video 120 of visual content, and display a three-dimensional rendered image for the first partial region 121, and display a two-dimensional rendered image for the second partial region 122.

In this case, the electronic device 1000 may generate and store information 123 for rendering a portion of the original video 120 of the visual content in three dimensions and rendering another portion of the original video 120 in two dimensions. For example, the electronic device 1000 may store information 124 related to 3D rendering for the first partial region 121, as information related to a 3D rendered image for the first partial region 121. In addition, for example, the electronic device 1000 may store information 125 related to 2D rendering for the second partial region 122, as information related to a 2D rendered image for the second partial region 122.

For example, information related to a rendered image of visual content may include information on which entity or region of a 2D video is to be rendered in three dimensions at a specific point of time. Referring to FIG. 12, for example, <Partial 3D> of 3D conversion data may include information on which effect is to be applied to which entity at a point of time <Start Time=00>. <Partial 3D> may include metadata 124 for one 3D object effect and metadata 125 for one 2D object effect. The metadata 124 may include a boundary of an entity that is to be expressed as a 3D object, and depth information required for converting the entity in 3D, in an encoded text form and as a DepthInfo value. In addition, the metadata 125 may include entity information that is to appear in a 2D form at the same point of time. Accordingly, in the process of rendering the original 2D video through the video playback application, the electronic device 1000 may apply a partial 3D effect only to a middle person according to the <<3D Object>> information 124 of the 3D conversion data, and may apply a 2D effect to a subtitle position of a video according to the <<2D Object>> information 125.

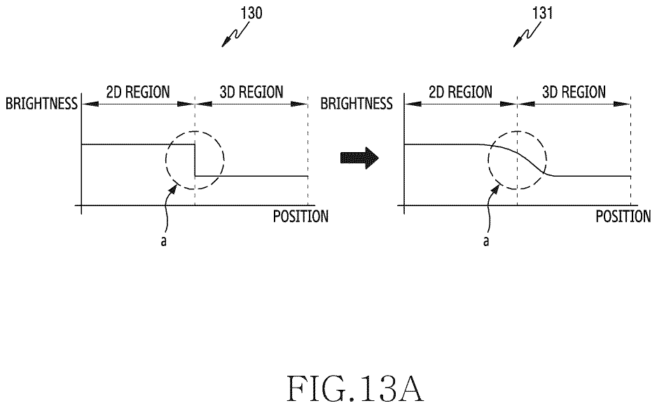

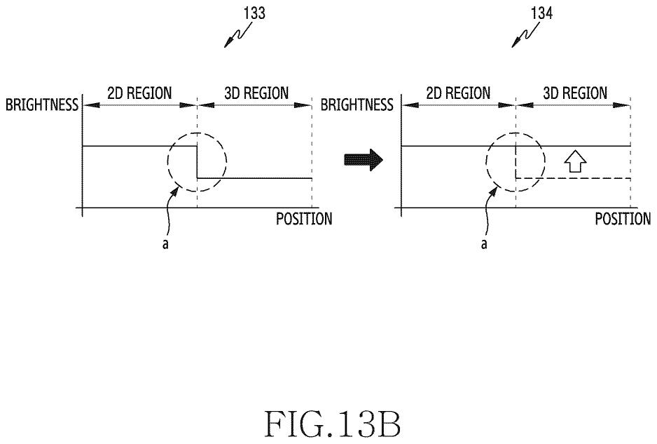

FIG. 13A is a diagram illustrating an example of controlling the brightness of a boundary between a first rendered image and a second rendered image in an electronic device according to an embodiment of the disclosure.

Referring to FIG. 13A, as indicated by reference numeral 130 in a boundary portion (a) between a 2D region where a 2D rendered image is displayed and a 3D region where a 3D rendered image is displayed, the brightness of the 2D region may be discretely different from the brightness of the 3D region. For example, the brightness of the 3D rendered image of visual content may be less than the brightness of the 2D rendered image.

Referring to reference numeral 131 of FIG. 13A, by controlling the brightness of the 2D region and the brightness of the 3D region, an electronic device 1000 may allow the brightness of the 2D region and the brightness of the 3D region to have continuous values, in the boundary portion (a) between the 2D region where the 2D rendered image is displayed and the 3D region where the 3D rendered image is displayed.

FIG. 13B is a diagram illustrating an example of controlling the brightness of a first rendered image and a second rendered image in an electronic device according to an embodiment of the disclosure.

Referring to FIG. 13B, as shown by reference numeral 133, in a boundary portion (a) between a 2D region where a 2D rendered image is displayed and a 3D region where a 3D rendered image is displayed, the brightness of the 2D region may be discretely different from the brightness of the 3D region. For example, the brightness of the 3D rendered image of visual content may be less than the brightness of the 2D rendered image.

Referring to reference numeral 134 of FIG. 13B, by increasing the brightness of the 3D region, an electronic device 1000 may allow the brightness of the 2D region and the brightness of the 3D region to have continuous values, in the boundary portion (a) between the 2D region where the 2D rendered image is displayed and the 3D region where the 3D rendered image is displayed.

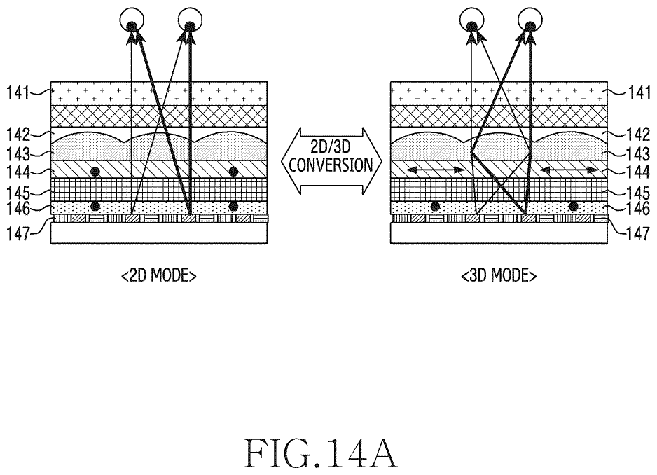

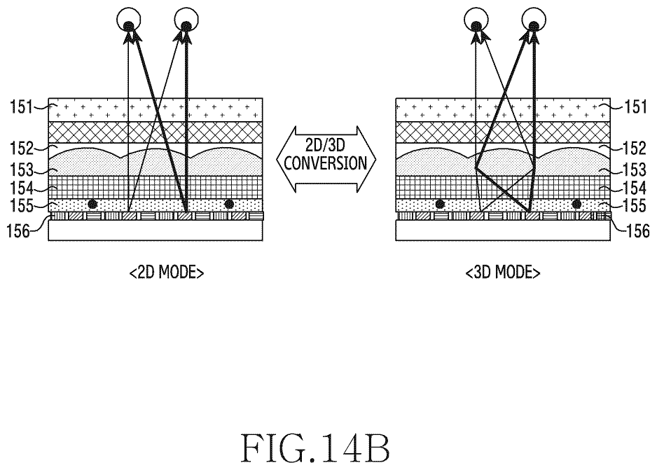

FIG. 14A is a diagram illustrating a display structure providing a two-dimensional display and a three-dimensional display according to an embodiment of the disclosure.

Referring to FIG. 14A, a display panel structure of an embodiment may include a touch panel 141, an index matching layer 142, a lens layer 143, a polarization rotation layer 144, a polarization rotation control layer 145, a polarization layer 146, and a display panel 147.

The lens layer 143 may include a micro lens layer filled with an anisotropic material, and the polarization rotation layer 144 may be disposed beneath the lens layer 143. The polarization rotation layer 144 may change the direction of polarization, and thus a 2D display and a 3D display may be implemented.

The polarization rotation control layer 145 for partially controlling the polarization rotation layer 144 may be disposed beneath the polarization rotation layer 144. For example, the polarization rotation control layer 145 may include a circuit for partially controlling the rotation of the polarization rotation layer 144.

The lens layer 143 may be composed of a non-isotropic (anisotropic) material such as liquid crystal (LC), and the index matching layer 142 may be disposed on the lens layer 143. The index matching layer 142 may be composed of a material having a refractive index equal to “no” among “ne” (higher refractive index among two refractive indices) and “no” (lower refractive index among the two refractive indices) of the anisotropic material.

When at least a partial region of a display according to an embodiment of the disclosure is set as a 2D mode region, a two-dimensional rendered image may be displayed in the 2D mode region. Linearly polarized light emitted through the 2D mode region from the polarization layer 146 may be emitted to the outside of the display without optical deformation, while passing through the off-state polarization rotation layer 144 that does not affect a path of light, and passing through the lens layer 143 and the index matching layer 142 having the same refractive index.

When the region of the display is set as a 3D mode region, a three-dimensional rendered image may be displayed in the 3D mode region. The polarization direction of linearly polarized light emitted through the polarization layer 146 may be rotated by 90 degrees, while the linearly polarized light passes through the on-state polarization rotation layer 144. In this case, a refractive index of the lens layer 143 may be different from a refractive index of the index matching layer 142 and accordingly, an optical path of the linearly polarized light may change due to a difference between the refractive index of the lens layer 143 and the refractive index of the index matching layer 142, and thus a three-dimensional rendered image may be displayed in the 3D mode region.

FIG. 14B is a diagram illustrating a display structure providing a two-dimensional display and a three-dimensional display according to an embodiment of the disclosure.

Referring to FIG. 14B, a display panel structure according to an embodiment of the disclosure may include a touch panel 151, an index matching layer 152, a lens layer 153, a lens control layer 154, a polarization layer 155, and a display panel 156.

The lens layer 153 may include a micro lens layer filled with an anisotropic material, and the lens control layer 154 may be disposed beneath the lens layer 153. The lens control layer 154 may adjust the arrangement of liquid crystal (LC) within the lens layer 153, based on a voltage applied to the lens control layer 154 and thus, 2D display and 3D display may be implemented. For example, the lens control layer 154 may include a circuit for partially controlling the arrangement of liquid crystal (LC) within the lens layer 153.

The lens layer 153 may be composed of a non-isotropic (anisotropic) material such as liquid crystal (LC), and the index matching layer 152 may be disposed at a top of the lens layer 153. The index matching layer 152 may be composed of a material having a refractive index equal to “no” among “ne” (higher refractive index among two refractive indices) and “no” (lower refractive index among the two refractive indices) of the anisotropic material.

When at least a partial region of a display according to an embodiment of the disclosure is set as a 2D mode region, a two-dimensional rendered image may be displayed in the 2D mode region. Linearly polarized light emitted through the 2D mode region from the polarization layer 155 may be emitted to the outside of the display without optical deformation, while passing through the lens layer 153 and the index matching layer 152 having the same refractive index.

When the region of the display is set as a 3D mode region, a three-dimensional rendered image may be displayed in the 3D mode region. When voltage is applied to the lens control layer 154, the arrangement of LC within the lens layer 153 may be changed, and accordingly, a refractive index of linearly polarized light may be changed. Accordingly, linearly polarized light emitted through the polarization layer 155 passes through the lens layer 153 and the index matching layer 152 having different refractive indices, and an optical path of the linearly polarized light is changed due to a difference between a refractive index of the lens layer 153 and a refractive index of the index matching layer 152, and thus the three-dimensional rendered image may be displayed in the 3D mode region.

A method for displaying visual content in an electronic device of an embodiment may include identifying setting information on a rendering dimension that is set for a first visual content, the rendering dimension including a 2D rendering dimension and a 3D rendering dimension, identifying, based on the setting information, a first display area corresponding to the first rendering dimension from a display area of the first visual content, the first rendering dimension being different from the second rendering dimension, and displaying a first rendered image and a second rendered image together wherein the first rendered image of the first visual content in the first rendering dimension is displayed in the first display area, and the second rendered image of the first visual content in the second rendering dimension is displayed in the second display area.

In addition, the method may include receiving a user input for selecting a partial region of the first rendered image, generating a third rendered image, corresponding to the partial region, of the first visual content, the third rendered image having the second rendering dimension different from the first rendering dimension, and replacing the partial region of the first rendered image with the third rendered image.

In addition, the method may include displaying a menu for setting the rendering dimensions, the menu including items indicating types of visual content, selecting at least one of the items, and setting a rendering dimension for the first visual content, based on the selected at least one item.

In addition, the menu may include items indicating types of visual objects included in the visual content, and the setting of the rendering dimension may include selecting at least one of the items indicating the types of the visual objects, and setting a rendering dimension for a visual object in the first visual content, based on to the selected at least one item.

In addition, the menu may include items indicating types of applications for displaying the visual content, and the setting of the rendering dimension may include selecting at least one of the items indicating the types of the applications, and setting a rendering dimension for an application executing the first visual content, based on the selected at least one item.

In addition, the receiving of the user input for selecting the partial region may include receiving a user input for selecting a visual object within the first rendered image, and the generating of the third rendered image corresponding to the partial region may include generating the third rendered image of the selected visual object.

In addition, the user input for selecting the partial region may include at least one of a user input for gazing at the partial region for a specified time or longer or a user input for touching the partial region for a specified time or longer.

In addition, the replacing may include displaying the third rendered image, together with the first rendered image from which the partial region has been excluded and the second rendered image.

In addition, the method may include displaying a fourth rendered image of a second visual content related to the first visual content, the fourth rendered image of the second visual content having the first rendering dimension, receiving a user input for selecting the first visual content, and replacing the fourth rendered image of the second visual content with a fifth rendered image of the second visual content, in response to the first visual content being selected, and the fifth rendered image may have the second rendering dimension different from the first rendering dimension.

In addition, the displaying of the first rendered image and the second rendered image comprises: merging at least a portion of the first rendered image with at least a portion of the second rendered image; and displaying the merged rendered image on a display.

In addition, the first rendered image includes an image of a human face, and wherein the second rendered image does not include an image of a human face.

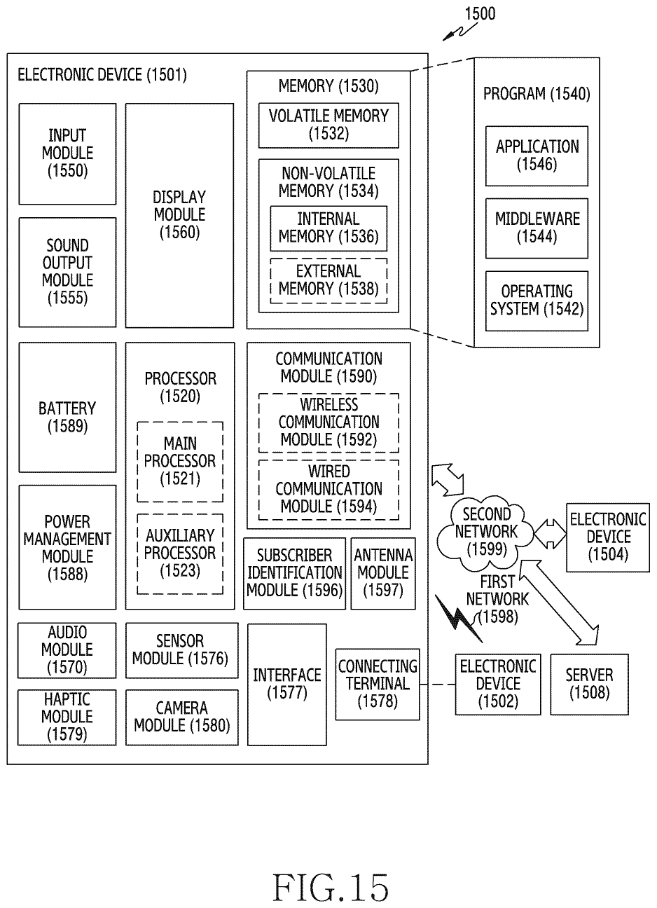

FIG. 15 is a block diagram illustrating an electronic device 1501 in a network environment 1500 according to an embodiment of the disclosure.

Referring to FIG. 15, the electronic device 1501 in the network environment 1500 may communicate with an electronic device 1502 via a first network 1598 (e.g., a short-range wireless communication network), or at least one of an electronic device 1504 or a server 1508 via a second network 1599 (e.g., a long-range wireless communication network). According to an embodiment, the electronic device 1501 may communicate with the electronic device 1504 via the server 1508. According to an embodiment, the electronic device 1501 may include a processor 1520, memory 1530, an input module 1550, a sound output module 1555, a display module 1560, an audio module 1570, a sensor module 1576, an interface 1577, a connecting terminal 1578, a haptic module 1579, a camera module 1580, a power management module 1588, a battery 1589, a communication module 1590, a subscriber identification module(SIM) 1596, or an antenna module 1597. In some embodiments, at least one of the components (e.g., the connecting terminal 1578) may be omitted from the electronic device 1501, or one or more other components may be added in the electronic device 1501. In some embodiments, some of the components (e.g., the sensor module 1576, the camera module 1580, or the antenna module 1597) may be implemented as a single component (e.g., the display module 1560).

The processor 1520 may execute, for example, software (e.g., a program 1540) to control at least one other component (e.g., a hardware or software component) of the electronic device 1501 coupled with the processor 1520, and may perform various data processing or computation. According to one embodiment, as at least part of the data processing or computation, the processor 1520 may store a command or data received from another component (e.g., the sensor module 1576 or the communication module 1590) in volatile memory 1532, process the command or the data stored in the volatile memory 1532, and store resulting data in non-volatile memory 1534. According to an embodiment, the processor 1520 may include a main processor 1521 (e.g., a central processing unit (CPU) or an application processor (AP)), or an auxiliary processor 1523 (e.g., a graphics processing unit (GPU), a neural processing unit (NPU), an image signal processor (ISP), a sensor hub processor, or a communication processor (CP)) that is operable independently from, or in conjunction with, the main processor 1521. For example, when the electronic device 1501 includes the main processor 1521 and the auxiliary processor 1523, the auxiliary processor 1523 may be adapted to consume less power than the main processor 1521, or to be specific to a specified function. The auxiliary processor 1523 may be implemented as separate from, or as part of the main processor 1521.

The auxiliary processor 1523 may control at least some of functions or states related to at least one component (e.g., the display module 1560, the sensor module 1576, or the communication module 1590) among the components of the electronic device 1501, instead of the main processor 1521 while the main processor 1521 is in an inactive (e.g., sleep) state, or together with the main processor 1521 while the main processor 1521 is in an active state (e.g., executing an application). According to an embodiment, the auxiliary processor 1523 (e.g., an image signal processor or a communication processor) may be implemented as part of another component (e.g., the camera module 1580 or the communication module 1590) functionally related to the auxiliary processor 1523. According to an embodiment, the auxiliary processor 1523 (e.g., the neural processing unit) may include a hardware structure specified for artificial intelligence model processing. An artificial intelligence model may be generated by machine learning. Such learning may be performed, e.g., by the electronic device 1501 where the artificial intelligence is performed or via a separate server (e.g., the server 1508). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1530 may store various data used by at least one component (e.g., the processor 1520 or the sensor module 1576) of the electronic device 1501. The various data may include, for example, software (e.g., the program 1540) and input data or output data for a command related thereto. The memory 1530 may include the volatile memory 1532 or the non-volatile memory 1534.

The program 1540 may be stored in the memory 1530 as software, and may include, for example, an operating system (OS) 1542, middleware 1544, or an application 1546.

The input module 1550 may receive a command or data to be used by another component (e.g., the processor 1520) of the electronic device 1501, from the outside (e.g., a user) of the electronic device 1501. The input module 1550 may include, for example, a microphone, a mouse, a keyboard, a key (e.g., a button), or a digital pen (e.g., a stylus pen).

The sound output module 1555 may output sound signals to the outside of the electronic device 1501. The sound output module 1555 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1560 may visually provide information to the outside (e.g., a user) of the electronic device 1501. The display module 1560 may include, for example, a display, a hologram device, or a projector and control circuitry to control a corresponding one of the display, hologram device, and projector. According to an embodiment, the display module 1560 may include a touch sensor adapted to detect a touch, or a pressure sensor adapted to measure the intensity of force incurred by the touch.

The audio module 1570 may convert a sound into an electrical signal and vice versa. According to an embodiment, the audio module 1570 may obtain the sound via the input module 1550, or output the sound via the sound output module 1555 or a headphone of an external electronic device (e.g., an electronic device 1502) directly (e.g., wiredly) or wirelessly coupled with the electronic device 1501.

The sensor module 1576 may detect an operational state (e.g., power or temperature) of the electronic device 1501 or an environmental state (e.g., a state of a user) external to the electronic device 1501, and then generate an electrical signal or data value corresponding to the detected state. According to an embodiment, the sensor module 1576 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1577 may support one or more specified protocols to be used for the electronic device 1501 to be coupled with the external electronic device (e.g., the electronic device 1502) directly (e.g., wiredly) or wirelessly. According to an embodiment, the interface 1577 may include, for example, a high definition multimedia interface (HDMI), a universal serial bus (USB) interface, a secure digital (SD) card interface, or an audio interface.

A connecting terminal 1578 may include a connector via which the electronic device 1501 may be physically connected with the external electronic device (e.g., the electronic device 1502). According to an embodiment, the connecting terminal 1578 may include, for example, a HDMI connector, a USB connector, a SD card connector, or an audio connector (e.g., a headphone connector).

The haptic module 1579 may convert an electrical signal into a mechanical stimulus (e.g., a vibration or a movement) or electrical stimulus which may be recognized by a user via his tactile sensation or kinesthetic sensation. According to an embodiment, the haptic module 1579 may include, for example, a motor, a piezoelectric element, or an electric stimulator.

The camera module 1580 may capture a still image or moving images. According to an embodiment, the camera module 1580 may include one or more lenses, image sensors, image signal processors, or flashes.

The power management module 1588 may manage power supplied to the electronic device 1501. According to one embodiment, the power management module 1588 may be implemented as at least part of, for example, a power management integrated circuit (PMIC).

The battery 1589 may supply power to at least one component of the electronic device 1501. According to an embodiment, the battery 1589 may include, for example, a primary cell which is not rechargeable, a secondary cell which is rechargeable, or a fuel cell.

The communication module 1590 may support establishing a direct (e.g., wired) communication channel or a wireless communication channel between the electronic device 1501 and the external electronic device (e.g., the electronic device 1502, the electronic device 1504, or the server 1508) and performing communication via the established communication channel. The communication module 1590 may include one or more communication processors that are operable independently from the processor 1520 (e.g., the application processor (AP)) and supports a direct (e.g., wired) communication or a wireless communication. According to an embodiment, the communication module 1590 may include a wireless communication module 1592 (e.g., a cellular communication module, a short-range wireless communication module, or a global navigation satellite system (GNSS) communication module) or a wired communication module 1594 (e.g., a local area network (LAN) communication module or a power line communication (PLC) module). A corresponding one of these communication modules may communicate with the external electronic device via the first network 1598 (e.g., a short-range communication network, such as Bluetooth™, wireless-fidelity (Wi-Fi) direct, or infrared data association (IrDA)) or the second network 1599 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1592 may identify and authenticate the electronic device 1501 in a communication network, such as the first network 1598 or the second network 1599, using subscriber information (e.g., international mobile subscriber identity (IMSI)) stored in the subscriber identification module 1596.

The wireless communication module 1592 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1592 may support a high-frequency band (e.g., the millimeter wave (mmWave) band) to achieve, e.g., a high data transmission rate. The wireless communication module 1592 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1592 may support various requirements specified in the electronic device 1501, an external electronic device (e.g., the electronic device 1504), or a network system (e.g., the second network 1599). According to an embodiment, the wireless communication module 1592 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1597 may transmit or receive a signal or power to or from the outside (e.g., the external electronic device) of the electronic device 1501. According to an embodiment, the antenna module 1597 may include an antenna including a radiating element composed of a conductive material or a conductive pattern formed in or on a substrate (e.g., a printed circuit board (PCB)). According to an embodiment, the antenna module 1597 may include a plurality of antennas (e.g., array antennas). In such a case, at least one antenna appropriate for a communication scheme used in the communication network, such as the first network 1598 or the second network 1599, may be selected, for example, by the communication module 1590 (e.g., the wireless communication module 1592) from the plurality of antennas. The signal or the power may then be transmitted or received between the communication module 1590 and the external electronic device via the selected at least one antenna. According to an embodiment, another component (e.g., a radio frequency integrated circuit (RFIC)) other than the radiating element may be additionally formed as part of the antenna module 1597.

According to various embodiments, the antenna module 1597 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1501 and the external electronic device 1504 via the server 1508 coupled with the second network 1599. Each of the electronic devices 1502 or 1504 may be a device of a same type as, or a different type, from the electronic device 1501. According to an embodiment, all or some of operations to be executed at the electronic device 1501 may be executed at one or more of the external electronic devices 1502, 1504, or 1508. For example, if the electronic device 1501 should perform a function or a service automatically, or in response to a request from a user or another device, the electronic device 1501, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1501. The electronic device 1501 may provide the outcome, with or without further processing of the outcome, as at least part of a reply to the request. To that end, a cloud computing, distributed computing, mobile edge computing (MEC), or client-server computing technology may be used, for example. The electronic device 1501 may provide ultra low-latency services using, e.g., distributed computing or mobile edge computing. In another embodiment, the external electronic device 1504 may include an internet-of-things (IoT) device. The server 1508 may be an intelligent server using machine learning and/or a neural network. According to an embodiment, the external electronic device 1504 or the server 1508 may be included in the second network 1599. The electronic device 1501 may be applied to intelligent services (e.g., smart home, smart city, smart car, or healthcare) based on 5G communication technology or IoT-related technology.

The electronic device 1501 of FIG. 15 may correspond to the electronic device 1000 of FIGS. 1, 2A, 2B, 3, 4A to 4C, 5, 6A to 6E, 7 to 12, 13A, 13B, 14A, and 14B, and the electronic device 1501 of FIG. 15 may perform the operations of the electronic device 1000 of FIGS. 1, 2A, 2B, 3, 4A to 4C, 5, 6A to 6E, 7 to 12, 13A, 13B, 14A and 14B.

According to an embodiment, an electronic device for displaying visual content may include a display structure including a display panel 156, a polarization layer 155, a lens layer 153, and a touch panel 151, a control circuit 154 configured to adjust refractive indices of a plurality of regions of the lens layer, memory 1530 configured to store instructions, and at least one processor 1520, and the instructions may, when executed by the at least one processor, cause the electronic device to identify setting information on a rendering dimension that is set for a first visual content, the rendering dimension including a two-dimensional (2D) rendering dimension and a three-dimensional (3D) rendering dimension, identify, based on the setting information, a first display area corresponding to a first rendering dimension and a second display area corresponding to a second rendering dimension, from a display area where the first visual content is to be displayed, the first rendering dimension being different from the second rendering dimension, and by controlling the control circuit, adjust the refractive indices of the lens layer wherein a first rendered image of the first visual content in the first rendering dimension is displayed in the first display area, and a second rendered image of the first visual content in the second rendering dimension is displayed in the second display area.

In addition, the first visual content includes video content, and the instructions may, when executed by the at least one processor, cause the electronic device to, by identifying a subtitle in the video content, identify the second display area corresponding to the second rendering dimension from the display area of the first visual content.

In addition, the instructions may, when executed by the at least one processor, cause the electronic device to receive a user input for selecting a partial region of the first rendered image, generate a third rendered image, corresponding to the partial region, of the first visual content, the third rendered image having the second rendering dimension different from the first rendering dimension, and replace the partial region of the first rendered image with the third rendered image.

In addition, the instructions may, when executed by the at least one processor, cause the electronic device to display a menu for setting the rendering dimensions, the menu including items indicating types of visual content, select at least one of the items, and set the rendering dimension for the first visual content, based on the selected at least one item.

In addition, the menu may include items indicating types of visual objects included in the visual content, and the instructions may, when executed by the at least one processor, cause the electronic device to select at least one of the items indicating the types of the visual objects, and set a rendering dimension for a visual object in the first visual content, based on to the selected at least one item.

In addition, the menu may include items indicating types of applications for displaying the visual content, and the instructions may, when executed by the at least one processor, cause the electronic device to select at least one of the items indicating the types of the applications, and set a rendering dimension for an application executing the first visual content, based on the selected at least one item.

In addition, the instructions may, when executed by the at least one processor, cause the electronic device to receive a user input for selecting a visual object within the first rendered image, and generate the third rendered image of the selected visual object.

In addition, the instructions may, when executed by the at least one processor, cause the electronic device to display the third rendered image, together with the first rendered image from which the partial region has been excluded and the second rendered image.

In addition, the instructions may, when executed by the at least one processor, cause the electronic device to display a fourth rendered image of a second visual content related to the first visual content, the fourth rendered image of the second visual content having the first rendering dimension, receive a user input for selecting the first visual content, and replace the fourth rendered image of the second visual content with a fifth rendered image of the second visual content, in response to the first visual content being selected, the fifth rendered image having the second rendering dimension different from the first rendering dimension.

In addition, the instructions may, when executed by the at least one processor, cause the electronic device to store information for rendering the third rendered image, corresponding to the partial region, of the first visual content, terminate the displaying of the first visual content, receive a user input for displaying the first visual content after the displaying of the first visual content has been terminated, and display, based on the stored information, the third rendered image, together with the first rendered image from which the partial region has been excluded, in response to the user input being received.

According to an embodiment, a computer-readable recording medium for recording a program for executing a method in a computer may be provided. The method may include identifying setting information on a rendering dimension that is set for a first visual content, the rendering dimension including a 2D rendering dimension and a 3D rendering dimension, identifying, based on the setting information, a first display area corresponding to the first rendering dimension from a display area of the first visual content, the first rendering dimension being different from the second rendering dimension, and displaying a first rendered image and a second rendered image together wherein the first rendered image of the first visual content in the first rendering dimension is displayed in the first display area, and the second rendered image of the first visual content in the second rendering dimension is displayed in the second display area.

According to an embodiment, the one or more non-transitory computer-readable storage media, the operations further comprising: receiving a user input for selecting a partial region of the first rendered image; generating a third rendered image, corresponding to the partial region, of the first visual content, the third rendered image having the second rendering dimension different from the first rendering dimension; and replacing the partial region of the first rendered image with the third rendered image.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1540) including one or more instructions that are stored in a storage medium (e.g., internal memory 1536 or external memory 1538) that is readable by a machine (e.g., the electronic device 1501). For example, a processor (e.g., the processor 1520) of the machine (e.g., the electronic device 1501) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device for displaying visual content, the electronic device comprising:
a display structure comprising a display panel, a polarization layer, a lens layer, and a touch panel;
a control circuit configured to adjust refractive indices of a plurality of regions of the lens layer;
memory, comprising one or more storage media, storing instructions; and
at least one processor communicatively coupled to the display structure, the control circuit, and the memory,
wherein the instructions, when executed by the at least one processor individually or collectively, cause the electronic device to:
identify setting information on a rendering dimension that is set for a first visual content, the rendering dimension comprising a two-dimensional (2D) rendering dimension and a three-dimensional (3D) rendering dimension,
identify, based on the setting information, a first display area corresponding to a first rendering dimension and a second display area corresponding to a second rendering dimension, from a display area where the first visual content is to be displayed, the first rendering dimension being different from the second rendering dimension, and
by controlling the control circuit, adjust the refractive indices of the lens layer,
wherein a first rendered image of the first visual content in the first rendering dimension is displayed in the first display area, and
wherein a second rendered image of the first visual content in the second rendering dimension is displayed in the second display area.

2. The electronic device of claim 1,
wherein the first visual content comprises video content, and
wherein the instructions, when executed by the at least one processor individually or collectively, further cause the electronic device to:
by identifying a subtitle in the video content, identify the second display area corresponding to the second rendering dimension from the display area of the first visual content.

3. The electronic device of claim 1, wherein the instructions, when executed by the at least one processor individually or collectively, further cause the electronic device to:
receive a user input for selecting a partial region of the first rendered image;
generate a third rendered image, corresponding to the partial region, of the first visual content, the third rendered image having the second rendering dimension different from the first rendering dimension; and
replace the partial region of the first rendered image with the third rendered image.

4. The electronic device of claim 1, wherein the instructions, when executed by the at least one processor individually or collectively, further cause the electronic device to:
display a menu for setting the rendering dimensions, the menu comprising items indicating types of visual content;
select at least one of the items; and
set the rendering dimension for the first visual content, based on the selected at least one item.

5. The electronic device of claim 4,
wherein the menu comprises items indicating types of visual objects comprised in the visual content, and
wherein the instructions, when executed by the at least one processor individually or collectively, further cause the electronic device to:
select at least one of the items indicating the types of the visual objects, and
set a rendering dimension for a visual object in the first visual content, based on to the selected at least one item.

6. The electronic device of claim 4,
wherein the menu comprises items indicating types of applications for displaying the visual content, and
wherein the instructions, when executed by the at least one processor individually or collectively, further cause the electronic device to:
select at least one of the items indicating the types of the applications, and
set a rendering dimension for an application executing the first visual content, based on the selected at least one item.

7. The electronic device of claim 3, wherein the instructions, when executed by the at least one processor individually or collectively, further cause the electronic device to:
receive a user input for selecting a visual object within the first rendered image; and
generate the third rendered image of the selected visual object.

8. The electronic device of claim 3, wherein the instructions, when executed by the at least one processor individually or collectively, further cause the electronic device to:
display the third rendered image, together with the first rendered image from which the partial region has been excluded and the second rendered image.

9. The electronic device of claim 1, wherein the instructions, when executed by the at least one processor individually or collectively, further cause the electronic device to:
display a fourth rendered image of a second visual content related to the first visual content, the fourth rendered image of the second visual content having the first rendering dimension;
receive a user input for selecting the first visual content; and
replace the fourth rendered image of the second visual content with a fifth rendered image of the second visual content, in response to the first visual content being selected, the fifth rendered image having the second rendering dimension different from the first rendering dimension.

10. The electronic device of claim 3, wherein the instructions, when executed by the at least one processor individually or collectively, further cause the electronic device to:
store information for rendering the third rendered image, corresponding to the partial region, of the first visual content;
terminate the displaying of the first visual content;
receive a user input for displaying the first visual content after the displaying of the first visual content has been terminated; and
display, based on the stored information, the third rendered image, together with the first rendered image from which the partial region has been excluded, in response to the user input being received.

11. A method for displaying visual content in an electronic device, the method comprising:
identifying setting information on a rendering dimension that is set for a first visual content, the rendering dimension comprising a two-dimensional (2D) rendering dimension and a three-dimensional (3D) rendering dimension;
identifying, based on the setting information, a first display area corresponding to the first rendering dimension from a display area of the first visual content, the first rendering dimension being different from a second rendering dimension; and
displaying a first rendered image and a second rendered image together,
wherein the first rendered image of the first visual content in the first rendering dimension is displayed in the first display area, and
wherein the second rendered image of the first visual content in the second rendering dimension is displayed in a second display area.

12. The method of claim 11, comprising:
receiving a user input for selecting a partial region of the first rendered image;
generating a third rendered image, corresponding to the partial region, of the first visual content, the third rendered image having the second rendering dimension different from the first rendering dimension; and
replacing the partial region of the first rendered image with the third rendered image.

13. The method of claim 11, comprising:
displaying a menu for setting the rendering dimensions, the menu comprising items indicating types of visual content;
selecting at least one of the items; and
setting a rendering dimension for the first visual content, based on the selected at least one item.

14. The method of claim 13,
wherein the menu comprises items indicating types of visual objects comprised in the visual content, and
wherein the setting of the rendering dimension comprises:
selecting at least one of the items indicating the types of the visual objects, and
setting a rendering dimension for a visual object in the first visual content, based on to the selected at least one item.

15. The method of claim 13,
wherein the menu comprises items indicating types of applications for displaying the visual content, and
wherein the setting of the rendering dimension comprises:
selecting at least one of the items indicating the types of the applications, and
setting a rendering dimension for an application executing the first visual content, based on the selected at least one item.

16. The method of claim 12,
wherein the receiving of the user input for selecting the partial region comprises receiving a user input for selecting a visual object within the first rendered image, and
wherein the generating of the third rendered image corresponding to the partial region comprises generating the third rendered image of the selected visual object.

17. The method of claim 12, wherein the user input for selecting the partial region comprises at least one of a user input for gazing at the partial region for a specified time or longer or a user input for touching the partial region for a specified time or longer.

18. The method of claim 12, wherein the replacing comprises:
displaying the third rendered image, together with the first rendered image from which the partial region has been excluded and the second rendered image.

19. The method of claim 11, comprising:
displaying a fourth rendered image of a second visual content related to the first visual content, the fourth rendered image of the second visual content having the first rendering dimension;
receiving a user input for selecting the first visual content; and
replacing the fourth rendered image of the second visual content with a fifth rendered image of the second visual content, in response to the first visual content being selected,
wherein the fifth rendered image has the second rendering dimension different from the first rendering dimension.

20. One or more non-transitory computer-readable storage media storing one or more computer programs including computer-executable instructions that, when executed by one or more processors of an electronic device individually or collectively, cause the electronic device to perform operations, the operations comprising:
identifying setting information on a rendering dimension that is set for a first visual content, the rendering dimension comprising a two-dimensional (2D) rendering dimension and a three-dimensional (3D) rendering dimension;
identifying, based on the setting information, a first display area corresponding to the first rendering dimension from a display area of the first visual content, the first rendering dimension being different from a second rendering dimension; and
displaying a first rendered image and a second rendered image together,
wherein the first rendered image of the first visual content in the first rendering dimension is displayed in the first display area, and
wherein the second rendered image of the first visual content in the second rendering dimension is displayed in a second display area.
